(19) United States
(12) Patent Application Publication
(10) Pub. No.: US 2002/0159434 A1
(43) Pub. Date: Oct. 31, 2002

(54) Multipoint short range radio frequency system

(75) Inventors: Jason J. Gosior, Edmonton, AB (US); Colin C. Broughton, Edmonton, AB (US); Louis D. Garner, Edmonton, AB (US); Lee E. Kruszewski, Edmonton, AB (US); John F. Sobota, Edmonton, AB (US)

Correspondence Address: RODMAN & RODMAN, 7 SOUTH BROADWAY, WHITE PLAINS, NY, 10601, US

(73) Assignee: Eleven Engineering Inc., Edmonton, AB (CA)

(21) Appl. No.: 09/780,405

(22) Filed: Feb. 12, 2001

(51) Int. Cl. H04J 3/16; H04J 3/00

(52) U.S. Cl. 370/350; 370/346; 370/336

(57) ABSTRACT

A robust multipoint master-slave radio frequency system for transmitting signals digitally using combination of reinforcing techniques including: 1) hybrid spread spectrum approaches, 2) adaptive frequency and time slot management, 3) graceful degradation of signal quality, and 4) time multiplexing of peripheral, sub-peripherals and base transceiver signals. An improved method of coordinating multiple base transceivers using a distributed control, synchronization and communication approach. Such an approach is not impacted by the loss or addition of a new base transceiver and adapts to changing radio frequency conditions.

### BACKGROUND OF THE INVENTION

The invention relates to the field of low power, short-range wireless data transmission between hosts (such as video game consoles, consumer electronic devices or data devices) with subtended base transceivers and remote peripherals and the coordination of multiple such systems operating within the same radio frequency domain. “Domain” is defined as devices that are within a local area where their radio transmissions can be heard by all radio frequency (RF) enabled devices. Domain is also referred to as a radio frequency operating range in the description of the invention.

The usefulness of radio frequency wireless solutions is well known. Such solutions eliminate the masses of wires interconnecting the various interfaces found on electronic devices. This results in more flexible and cost effective options for upgrades and reconfiguration of devices. Further radio frequency wireless versus infrared wireless solutions are not typically impacted by objects present in the line of site between transmitters and receivers, making RF configurations more flexible and less intolerant of physical environment features.

With the increasing visibility and utility of wireless technology for office and home applications, two very important issues arise. First the level of radio frequency interference continues to increase, introducing the need for more robust approaches to digital signal transmission for short range applications.

Second the pent up demand for wireless functionality in the home represents a significant opportunity if cost/performance design issues can be adequately addressed. Although systems need to be increasingly robust, subscribers are not willing to pay a significant price premium for such technology.

Cellular or other conventional wireless applications purposely operate in larger cells or RF areas typically designed to minimize overlap to the amount required for continuous signal reception. The type of applications to which this invention relates, however, are typically base transceiver systems in close vicinity due to the sharing of a common host system ports or the close location of multiple host systems with devices in dense multi-tenant dwellings configurations or personal area networks.

RF saturation problems occur when base transceivers are in close proximity. If one base transceiver is transmitting, while another is listening, the receiver of the second base transceiver will saturate even though it may be operating on a different frequency than the first transceiver. This occurs because the out of band signal from the first transceiver is sufficiently powerful to be seen as a signal for the second transceiver.

To resolve this problem a method of synchronizing adjacent base transceiver polling transmissions is required. The invention provides a robust, distributed approach to provide such synchronization without a connecting wired backbone and/or a centralized coordinating device.

Such an approach is not dependent upon having a primary base transceiver or master controller as the coordinator. Further in this approach no voting scheme is required to replace a primary base transceiver that can no longer act as the coordinator of a system of base transceivers.

Conventional systems of this nature include the wireless LAN implementation of 802.11. Operating in an infrastructure mode, 802.11 uses a beacon frame transmitted from a central access point to keep wireless stations synchronized. In another configuration of 802.11, an ad hoc configuration of peer-to-peer base transceiver communication is supported, but one of the associated machines needs to be elected to be the base station (master) of the network.

The invention has particular utility in gaming applications. U.S. Pat. No. 5,561,419 to Sasaki et al., (1996), “Wireless Communication Apparatus and Game Machine Using the Same” describes a master slave polling configuration for gaming in which multiple peripherals are time division multiplexed to a single host. Information is passed from the peripherals to the base transceiver (“master unit”) in a unidirectional fashion. No spread spectrum techniques are used. The configuration described relies on manual time delay configuration and is susceptible to environmental noise.

U.S. Pat. No. 5,806,849 to Rutkowski, (1998), “Electronic Game System with Wireless Controller” presents a long range, low speed uni-directional RF system for gaming. The system used multiple channel transmission frequencies, statically assigned, and used a single receiver to poll individual controller channels.

U.S. Pat. No. 4,531,740 to Green et al., (1985), “Remote Control System for a Video Computer Game” disclosed a remote controller system for a video computer game using RF transmission as a communication mechanism. The Green system was for a fixed, application specific controller and electronic game device configuration and did not provide for other uses. Green does not disclose use of spread spectrum and channel quality measurement techniques.

The invention also has application for wireless consumer electronic devices. U.S. Pat. No. 5,764,648 to Yamane et al., (1998), “Method and Apparatus for Generating a Transmission Timing Signal in a Wireless Telephone” describes a master slave system wherein a stand alone base station and wireless telephone pair exchange data packets and peripheral timing is coordinated by a base station synchronization signal. The system also describes how during reception in a first channel, the channel quality of another vacant channel is measured. Channels are seen as being either good or bad.

The invention also has application in wireless data communication. U.S. Pat. No. 5,862,171 to Mahany et al., (1999), “Radio Frequency Communication Network Having Adaptive Communication Parameters” describes a system with mobile transceivers communicating with a radio base transceiver in which the system adapts to operation conditions by varying the spreading codes used, changing hop frame lengths, coding and interleaving in frequency-hopping spread spectrum communications and adjusting data packet size.

U.S. Pat. No. 5,696,903 to Mahany, (1997), “Hierarchical Communications System Using Microlink, Data Rate Switching, Frequency Hopping and Vehicular Local Area Networking” describes a wireless RF system of multiple base stations and associated multiple peripheral devices that are controlled and coordinated over a common network by a central host computer.

The invention also has application in telecommunications. U.S. Pat. No. 6,154,655 to Borst et al., (2000), “Flexible Channel Allocation for a Cellular System Based on a Hybrid Measurement-Based Dynamic Channel Assignment and a Reuse-Distance Criterion Algorithm” describes a method of dynamically allocating channels in a cellular system using a measurements-based list of candidate channels and a dynamic reuse-distance algorithm.

### SUMMARY OF THE INVENTION

There is thus provided according to an aspect of the invention, a multiple point radio frequency (RF) transmission system that can be used for linking gaming applications, consumer electronics devices and personal computer data devices to remote peripherals.

According to certain aspects of the invention, the invention uses a polling-response architecture combined with spread spectrum techniques where a base transceiver is designated as the master and one or more peripherals serve as slaves.

The base transceiver may be attached to a host system and transmits messages to and from this host from a remote peripheral (single-point configuration) or peripherals (multipoint configuration). Base transceiver and peripheral(s) are arranged in a master slave wireless configuration utilizing a poll and response data transmission method.

A hybrid spread spectrum transmission method is preferably used. According to a further aspect of the invention, there are provided methods for synchronizing and coordinating the RF transmissions of multiple independent base transceivers and peripherals in close vicinity with overlapping RF domains.

Applications for the invention include short distance wireless RF video game controllers, wireless RF remote controls and peripherals for consumer electronic equipment such as set top boxes and stereos, and wireless peripherals and data links for personal computers.

Therefore, in accordance with an aspect of the invention, there is provided an RF system, comprising an RF section, a processor operably connected to the RF section, an input/output subsystem operably connected to the processor; and the processor being configured to control transmission of sync signals from the RF section in response to receiving sync signals at the RF section from another RF system.

In accordance with a further aspect of the invention, there is provided a method for exchanging information between transceivers, the method comprising the steps of transmitting and receiving signals, including sync signals, from a first base transceiver; and controlling transmission of sync signals from the first base transceiver in response to receiving sync signals from another base transceiver.

In accordance with a further aspect of the invention, there is provided an RF system, comprising an RF section, a processor operably connected to the RF section; an input/output subsystem operably connected to the processor and to a game console; and the processor being configured to scan a set of channels for at least one channel suitable for communication with another RF system.

In accordance with a further aspect of the invention, there is provided a method of exchanging game information between transceivers, the method comprising the steps of scanning a set of available channels for at least one channel suitable for communication between the transceivers; and exchanging game data between the transceivers using at least one suitable channel.

In accordance with a further aspect of the invention, there is provided an RF system, comprising an RF section, a processor operably connected to the RF section; an input/output subsystem operably connected to the processor and to a user interface, a manually operated switch operably connected to the processor, and the processor being configured to respond to operation of the manually operated switch to cause the RF section to transmit a request selected from the group consisting of a request for a change of time slot assignment for communications between the base transceiver and the RF system and a request for a change of base transceiver with which the RF system is to communicate.

In accordance with a further aspect of the invention, there is provided a method for changing communications between a base transceiver and an RF system, the method comprising the steps of assigning a time slot to a peripheral RF system for responding to a first base transceiver; and manually switching to a different time slot for sending information to the base transceiver.

In accordance with a further aspect of the invention, there is provided a method of exchanging data between transceivers, the method comprising sequentially repeating the steps of transmitting a polling volley from a base transceiver to plural peripheral transceivers, wherein the polling volley contains sequential packets addressed to the plural peripheral transceivers; and the plural peripheral transceivers responding in order to the polling volley after the termination of the polling volley.

In accordance with a further aspect of the invention, there is provided a method of exchanging data between plural base transceivers operating on a common frequency assignment and at least one peripheral transceiver associated with each base transceiver, the method comprising the steps of each of the plural base transceivers transmitting a sync packet at times at which none of the other of the plural base transceivers are transmitting a sync packet, each of the plural base transceivers listening for sync packets from others of the plural base transceivers; and each of the plural base transceivers adjusting a respective time clock associated with the base transceiver according to information contained in the sync packets.

In accordance with a further aspect of the invention, there is provided a method of exchanging data between transceivers, the method comprising sequentially repeating the steps of during a polling volley, each of plural base transceivers transmitting a data packet in different time slots on a single channel to a corresponding one of plural peripheral transceivers; and the plural peripheral transceivers responding in order to the packets in the polling volley after the termination of the polling volley.

In accordance with a further aspect of the invention, there is provided a method of synchronizing N plural transceivers, the method comprising the steps of:

each of the N plural transceivers transmitting a sync signal when none of the others of the N plural transceivers are transmitting a sync signal;

each of the N plural transceivers transmitting data in polling volleys;

each of the N plural transceivers transmitting a sync signal each N+1 polling volleys; and

each of the N plural transceivers synchronizing to the sync signals from the other base transceivers.

The input/output subsystem is operably connected to a host selected from the group consisting of a video game console, a set top box, a consumer electronic device, a computer and data networking equipment. The processor is preferably configured to cause:

a) the RF section to transmit polling volleys in a time division manner;

b) the RF section to transmit a sync signal in a sync slot associated with a polling volley

c) the RF section to transmit a sync signal in association with a first polling volley and then listen for sync signals from other RF systems in association with a subsequent polling volley;

d) the RF section to delay sending a sync signal when a sync signal is received from another RF system;

e) the RF section to advance the sending of a sync signal when a sync signal is no longer received from another RF system; and

f) to receive responses from peripherals transceiver in time slots associated with each polling volley, in which each peripheral transceiver is assigned a specific time slot.

A visual indicator may be operably connected to the processor for indicating a change in assignment of a time slot for a peripheral transceiver. Signal transmission preferably uses frequency hopping, with different transceivers on different frequencies at the same time. Random delay on power up is preferably used to avoid clashing with another base transceiver.

Channels are preferably selected for use that have a lower degree of impairment than channels not selected for use. A visual display is preferably used to provide an indication of the assigned time slot on the first base transceiver.

Further explanation of the invention is found in the claims and detailed disclosure.

### BRIEF DESCRIPTION OF THE DRAWINGS

There will now be described preferred embodiments of the invention, with reference to the drawings, by way of illustration only and not with the intention of limiting the scope of the invention, in which like numerals denote like elements and in which:

FIG. 1 illustrates a system architecture according to the invention with a single wireless peripheral;

FIG. 2 illustrates the system architecture with multiple wireless peripherals;

FIG. 3 illustrates multiple wireless systems operating within a common radio frequency domain;

FIG. 4a illustrates an exemplary electronic subsystem making up a wireless system;

FIG. 4b illustrates a peripheral configuration of the electronic subsystem utilizing an application specific integrated circuit (ASIC) controller;

FIG. 4c illustrates a base transceiver configuration of the electronic subsystem utilizing an ASIC controller;

FIG. 5 illustrates overlapping radio frequency domains between base transceivers that are closely located;

FIG. 6 illustrates polling volleys of multiple co-located wireless systems where the peripheral responses have been staggered to reduce interference;

FIG. 7 illustrates a mixed system composed of base transceivers supporting multiple member and single member groups of associated peripherals;

FIG. 8a illustrates a base transceiver polling packet format;

FIG. 8b illustrates a representative example of a base transceiver polling packet format for a wireless game application;

FIG. 9a illustrates a peripheral response packet format;

FIG. 9b illustrates a representative example of a base transceiver response packet format for a wireless game application;

FIG. 10 illustrates the reduction in signal interference by staggering the channel frequency of a remote base transceiver;

FIG. 11a illustrates a synchronization packet format;

FIG. 11b illustrates a representative example of a base transceiver synchronization packet format for a wireless game application;

FIG. 12a illustrates how synchronization packets are added and removed as new base transceivers are added or removed from an area having overlapping radio frequency domains;

FIG. 12b illustrates how base transceiver state information changes as a new base transceiver is added to the system;

FIG. 13 illustrates the layered software structure and the interactions between layers for firmware for use in and embodiment of the invention;

FIG. 14 illustrates the power up and radio frequency configuration process for a base transceiver;

FIG. 15 illustrates the process of establishing a radio frequency wireless link between a base transceiver and a peripheral;

FIG. 16 illustrates the process of resizing a connection as an example of the messaging process between the base transceiver and the peripheral;

FIG. 17 illustrates the process of bit and word synchronization as new radio frequency packet is received by a transceiver;

FIG. 18 illustrates the process of adjusting the poll packet start time of a first base transceiver based on a synchronization packet Start Code reference point;

FIG. 19 illustrates the process of configuring multiple base transceivers with a single peripheral capacity to use a common operating frequency;

FIG. 20 illustrates the process of manually changing a peripheral's time slot by applying the connection selection switch;

FIG. 21 illustrates the process of adapting the signal transmission method and operating channels to counteract rising noise levels;

### DETAILED DESCRIPTION OF PREFERRED EMBODIMENTS.

In this patent document, the word “comprising” is used in its non-limiting sense to mean that items following the word in the sentence are included and that items not specifically mentioned are not excluded. The use of the indefinite article “a” in the claims before an element means that one of the elements is specified, but does not specifically exclude others of the elements being present, unless the context clearly requires that there be one and only one of the elements. The terms “data” or “information” or “signals” refer to an electrical or electromagnetic signal carrying data. The term “colocated” means located in sufficient proximity that signal transmission from one transceiver interferes with signal transmission from another. The term “clash” or “collide” or “collision” refers to interference between signals received at a transceiver that impairs reception to such an extent to render use of the signal impractical. A RF system or base transceiver or peripheral transceiver is a combination of elements including RF section, processor and input/ouput subsystem. An RF section comprises a transceiver and receiver, a receive signal strength indicator (RSSI) for detecting signal strength, and associated equipment.

The RF system described here in its various aspects provides a unique solution for home and local area business environment radio frequency wireless applications. It provides a robust radio frequency solution for standalone and multiple overlapping system configurations for gaming, consumer electronic and local area data applications.

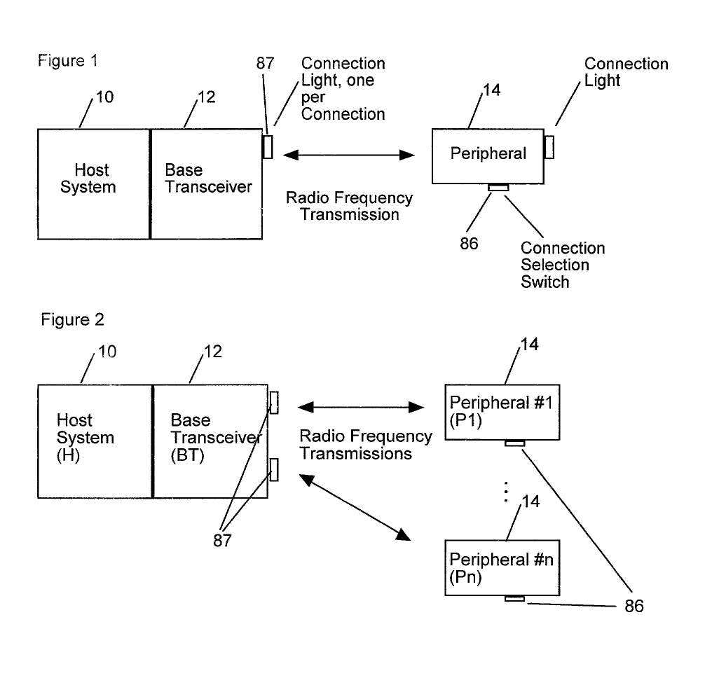

Referring to FIG. 1, the system architecture consists of three basic components: 1) a host system 10, 2) a base transceiver 12, and 3) one or more peripheral devices 14 linked wirelessly to the base transceiver 12 in a local area. FIG. 2 illustrate a system with n peripheral transceivers 14 associated with a single base transceiver 12. All the peripheral transceivers 14 may be identically constructed, differing only in their addresses.

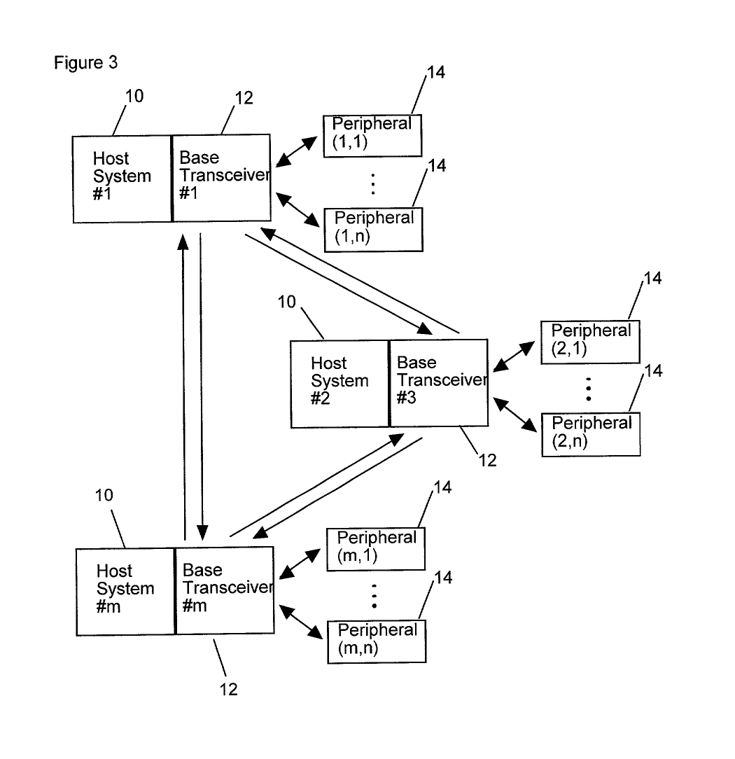

One or more such systems can exist in a given local area as illustrated in FIG. 3. FIG. 3 shows m such systems each having 1 up to n peripherals 14 and each system communicating to every other system within range by RF listening, described below, between base transceivers 12.

Examples of the host system 10 include devices such as video game consoles, set top boxes, consumer electronic devices, computers and data networking equipment. Each host system 10 is interfaced to its associated base transceiver 12 by a communications link such as a conventional wired interface, typically of an electrical or optical nature. It sends commands and data to and from the base transceiver 12, which in turn will then interact with the peripheral 14.

The base transceiver 12 is the master of the radio frequency system. It is responsible for polling the peripherals 14 and processing their responses. It provides a mediation role between the peripherals 14 and the host system 10 by translating and interpreting the information being sent from the peripherals 14 and interacting appropriately with the host 10.

The base transceiver 12 may support various peripheral combinations of various types including: 1) a single peripheral 14, 2) multiple peripherals 14, or 3) peripherals 14 and sub-peripherals. A sub-peripheral is one of several components that make up a physically divisible peripheral 14. For example, a game controller might be provided with a steering device and gas pedal. The steering column may be one sub-peripheral, and the gas pedal another. Each of these devices has independent RF wireless transceivers.

The peripheral 14 is wirelessly linked to the base transceiver 12. It interacts with users or electronic devices in the environment through a user interface. In the case of a video game console host, the user is the person playing the game. With a set top box host, the peripheral could be a remote control, wireless keyboard or other interactive device. It thus has a wireless interface associated with the base transceiver and also physical and electrical interfaces interacting with the environment.

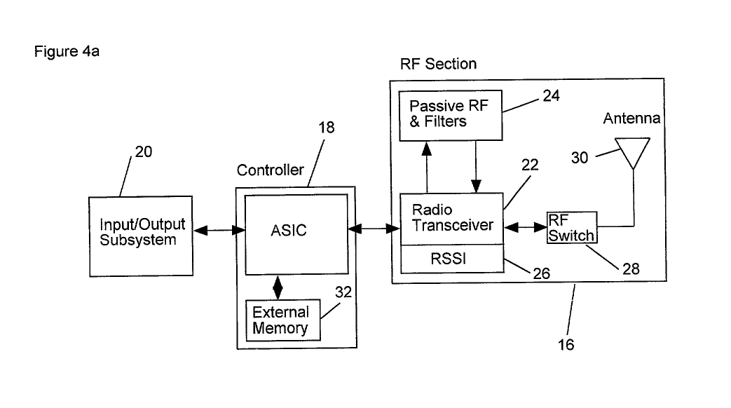

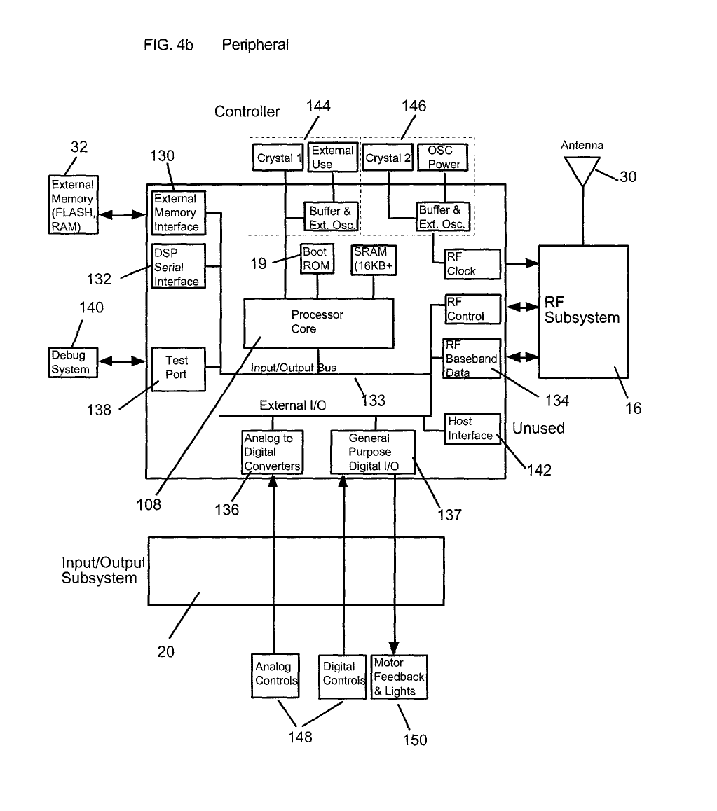

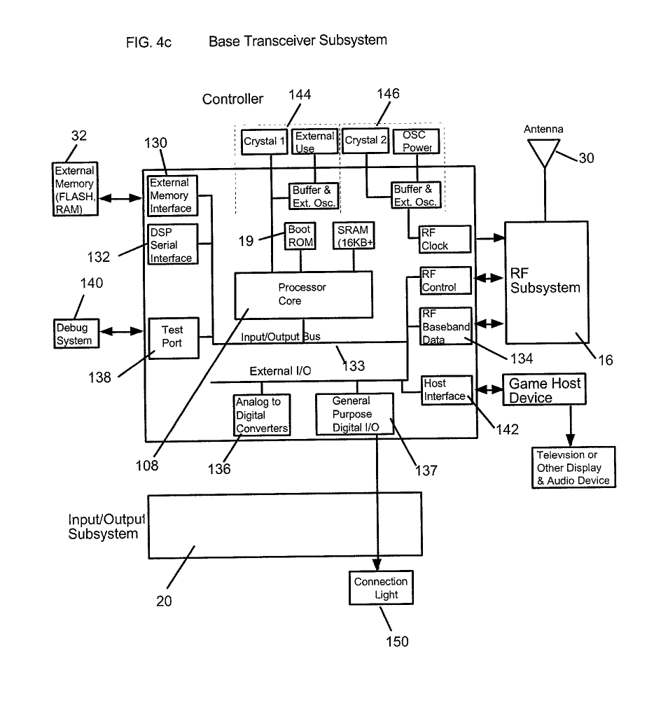

The base transceiver 12 and peripherals 14 are implemented using a similar overall design, as shown in FIG. 4a, with variations appropriate per device. Both consist of an RF section 16 connected by a conventional communications link to a controller 18, which in turn is connected by a conventional communications link to an input/output sub-system 20. In the case of the peripheral 14, the input/output subsystem 20 is connected to the user interface, and in the case of the base transceiver 12, the input/output subsystem 20 connects to the host system 10. In the peripheral case, typical inputs for gaming and consumer electronic applications include analog and digital buttons, joysticks, triggers and audio inputs, whereas for data applications this includes data type interfaces such as RS-232, USB and others. Typical outputs handled by the peripheral include “rumble” motors for game applications, and audio, graphic, video and other data signal outputs for more generic applications, where the more generic applications are supported by additional output electronics e.g. audio amplifiers, display drivers etc.

The RF section 16 may be formed of a radio frequency transceiver integrated circuit 22 such as a Tokaido RF IC from Microlinear or TRF 6900 available from Texas Instruments, associated passive RF components and filters 24 linked to the RF transceiver 22, a conventional received signal strength indicator 26 (RSSI) for providing a received signal strength to the controller 18, an RF switch 28 with matching circuitry and antenna 30. The controller 18 is a special purpose ASIC (application specific integrated circuit) configured as described in this patent document and provides baseband processing and control functions.

The radio transceiver 22 uses a modulation method, such as frequency shift keying, and has frequency agility to support spread spectrum techniques including spreading as well as frequency agility. The RF architecture described is independent of the exact modulation technique used and frequency operation range chosen. The system uses frequencies designated by FCC rules such as the 900 MHz ISM band and the 2.4 GHz ISM band and preferably supports channel spacings of 4 MHz or more. The RF System preferably supports up to 16 independent peripherals operating in a common area radio frequency operating range, but the number of peripherals can be increased by reducing their individual bandwidth allocation, by improving the modulation efficiency (more bits per hertz) or by increasing the adjacent channel isolation.

The RF transceiver 22 interfaces with the antenna circuitry 30 to send and receive wireless signals and may control an external RF switch 28 to control transmission direction. The RF transceiver 22 contains RSSI circuitry 26 that allows it to measure the signal strength across the entire radio frequency spectra operating band. The RF transceiver 22 is controlled by the controller 18.

The controller 18 provides control functions (e.g. set up, transmission direction etc.) and data to the RF transceiver 22. The controller 18 may be a 16 bit integrated microcontroller with an eight or more thread architecture. Preferably, the controller 18 includes at least 16 kwords of 2 port RAM. One port is read, the other write. External flash and RAM memory 32 may be used for booting, system operation and to store operating parameters between uses. The controller 18 also includes conventional ROM 19 to contain a boot loader and baseband decode tables. Preferably, the controller 18 has a clock rate of at least 12 MHz, divided between the available threads. Each thread is responsible for parallel time critical tasks performed by the ASIC e.g. receiving and transmitting radio signals and communicating with the host. The controller might also alternately be implemented with a sufficiently fast microcontroller or similar device also supporting input/output functions.

Firmware implementing the methods described here may be written in C and loaded through the flash memory 32 to a processor core 108 shown in FIGS. 4b and 4c. As shown in FIG. 13, firmware for the controller is organized in three layers: 1) a radio frequency (RF) layer 110, 2) an adaptation layer 112, and 3) an application layer 114. Because of the layered structure, implementation specific details can be changed relatively easily on a per layer basis. Using multi-thread architecture, each layer 110, 112, 114 executes in parallel on one or more separate execution threads and coordinates operations with other layers using message passing. The RF layer 110 is responsible for establishing, maintaining and tearing down connections. The adaptation layer 112 performs data translation, compression and verification e.g. voice compression, converting controller data into a format understood by a host system application. The application layer 114 controls all interfaces external to the system, except the RF interfaces which are controlled directly by the RF layer, is responsible for the power up sequence and coordinates other global functions of the system such as device inventories, resets and upgrades. Both adaptation and application layers are “application” specific and hence change with each particular application. The functions performed by the RF layer are common to all applications and are the subject of this invention.

Interactions between layers, such as between the RF layer 110 of one device and the RF layer 110 on a second device, are controlled using a series of messages. This messaging system allows the various layers to operate without interfering with each other. Messages are included as payload in the overall packet structures described below.

RF to RF layer messages occur between the RF layers 110 of two respective devices, and are used mainly for maintenance of connection-oriented communications and to provide a data carrying function for messages of higher layers. These messages always come in pairs and are always originated from a base transceiver 12. The table below shows the various RF messages supported by the system. Messages originate from the base transceiver 12 and are replied to by the peripheral 14. Base transceiver (BT) messages are prefixed by “bt” and peripheral (P) messages are prefixed by “p”. As with all messages, message IDs (identifiers) are used to identify the message type. During start up, mating numbers (device identification numbers) are exchanged and then a short mating number is assigned to identify a given established connection e.g. an RF link between a base transceiver 12 and an individual peripheral 14. Frequency hopping of peripherals is coordinated by the base transceiver through channel change commands.

TABLE 1
RF to RF Messages

| MESSAGE | PURPOSE | PARAMETERS | EXPECTED RESPONSE |
|---|---|---|---|
| BtJOIN | Base transceiver requests | Message ID, BT mating number, | PJOIN |
| | peripheral to join a base | offered peripheral time slot, | |
| | transceiver | polling period, expected packet | |
| | | length, Host type, firmware and | |
| | | protocol version | |
| PJOIN | Peripheral indicates it wishes | Message ID, BT mating number, | btJOIN_ACCEPT |
| | to join the base transceiver | P mating number, peripheral | |
| | | type, firmware and protocol | |
| | | version, manual join flag | |
| | | (indicates a user-activated switch | |
| | | operation prompted a new join) | |
| btJOIN_ACCEPT | Acceptance of a pJOIN | Message ID, BT mating number, | pJOIN_ACCEPT or |
| | request. The peripheral can | P mating number, timeslot, short | pCLOSE_CONNECTION |
| | join or reject the connection. | mating number, pass/fail flag | |
| pJOIN_ACCEPT | Peripheral accepts the | Message ID, BT mating number, | None |
| | conditions of a given channel. | P mating number, timeslot, short | |
| | | mating number | |
| btCLOSE_CONNECTION | Sent by the base transceiver | Message ID, closing settings, | pCLOSE_CONNECTION |
| | wanting to close a connection | short mating number | |
| pCLOSE_CONNECTION | Sent by the peripheral to | Message ID, closing settings, | None |
| | confirm connection closure. | short mating number | |
| btRESIZE_CONNECTION | Sent by the base transceiver | Message ID, short mating | pRESIZE_CONNECTION |
| | to resize a connection. | number, new connection size | |
| | | (expected payload size) or rate | |
| | | (less payload per poll volley) | |
| pRESIZE_CONNECTION | Sent by the peripheral to | Message ID (with embedded flag | None |
| | acknowledge a resized | to confirm resize accepted), short | |
| | connection. | mating number, new connection | |
| | | size | |
| btIDLE | Message sent by base | Message ID, short mating | None |
| | transceiver to maintain a data | number | |
| | link when no data is to be | | |
| | transmitted. | | |
| pIDLE | Message sent by peripheral | Message ID, short mating | None |
| | to maintain a data link when | number | |
| | no data is to be transmitted. | | |
| btCHANNEL_CHANGE | Base transceiver request to a | Message ID, new channel | pCHANNEL_CHANGE |
| | peripheral to change a | number, request/commit state, | |
| | channel for frequency | short mating number | |
| | hopping purposes. This | | |
| | message can be sent twice, | | |
| | once to request commitment | | |
| | and then again to commit to a | | |
| | channel change on the next | | |
| | polling volley or just once to | | |
| | commit. | | |
| pCHANNEL_CHANGE | Sent by the peripheral to | Message ID, new channel | None |
| | acknowledge a channel | number, request/commit state, | |
| | change request. | short mating number | |
| btRESET | Sent by the base transceiver | Message ID, short mating | pRESET |
| | to the peripheral to request a | number | |
| | peripheral reset as required | | |
| | by higher protocol layers. | | |
| pRESET | Confirms peripheral reset will | Message ID, short mating | None |
| | occur after message | number | |
| | transmission. | | |
| btSCAN_CHANNEL | Base transceiver requests a | Message ID, short mating | pSCAN_CHANNEL |
| | peripheral to scan a certain | number, channel(s) selection | |
| | channel or channels for noise | flags. | |
| | and transmission activity. | | |
| pSCAN_CHANNEL | Peripheral acknowledges a | Message ID, short mating | btSCAN_RESULTS |
| | base transceiver message. | number, error code (scan not | |
| | | possible). | |
| btSCAN_RESULTS | Base transceiver requests | Message ID, channel flags, short | pSCAN_RESULTS |
| | the results of a channel scan | mating number | |
| | from a given peripheral. | | |
| | Channel results are | | |
| | requested using channel | | |
| | flags. | | |
| pSCAN_RESULTS | Peripheral responds with | Message ID, message length, | None |
| | scan results | channel(s) data | |
| btTEST_MODE | Base transceiver requests | Message ID, test type, short | pTEST_MODE |
| | peripheral test to be | mating number | |
| | completed. This may | | |
| | involved the RF and/or higher | | |
| | layers depending on the test | | |
| | nature e.g. RF loop around. | | |
| pTEST_MODE | Peripheral responds to the | Message ID, test type, test data | None |
| | base transceiver test request. | results (if applicable), short | |
| | | mating number | |
| btPOLL_DATA | Standard poll sequence | Message ID, message length, | pPOLL_DATA |
| | message sent from the base | payload data, short mating | |
| | transceiver to send data to | number. | |
| | and request data from a | | |
| | peripheral. | | |
| pPOLL_DATA | Standard poll sequence | Message ID, message length, | btPOLL_DATA |
| | message sent from the | payload data, short mating | |
| | peripheral to send data to | number. | |
| | and request data from a base | | |
| | transceiver. | | |

RF layer 110 to adaptation layer 112 messages occur between adjacent layers on a single controller in order to facilitate communications between the two layers. These messages are used primarily to request and to obtain information about connection changes, to send and receive data to the RF layer 110 for transmission, and to facilitate testing. These messages are typically paired. The table below shows a representative example of RF to adaptation messages needed to support RF layer 110 operations. The exact format and content of these messages changes depending on the application type supported. The messages shown are for a game peripheral application.

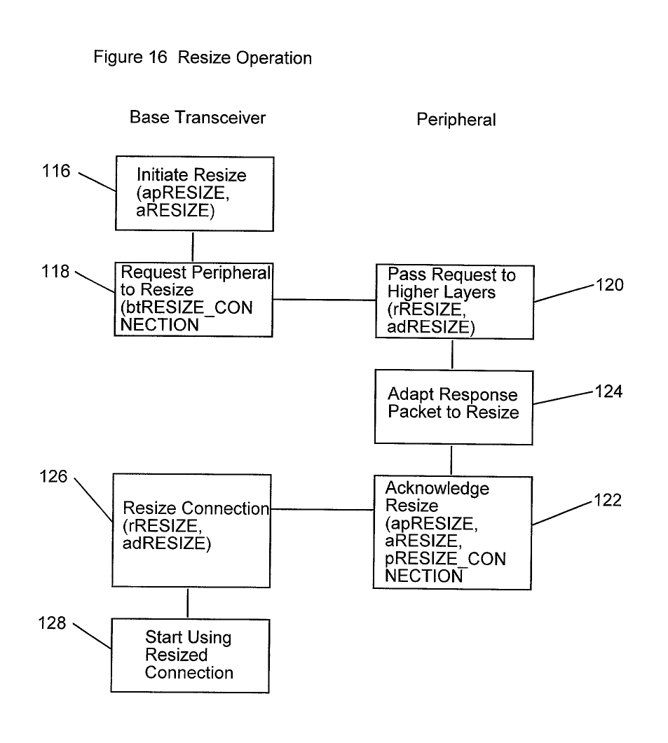

Adaptation to RF layer messages are prefixed by “a” and RF to adaptation layer messages are prefixed by “r”. The exact message sequence depends on whether the message flow starts in the base transceiver or in the peripheral or in one layer or another. For example, a rRESIZE message may be issued by the RF layer 110 to the adaptation layer 112 to tell this layer it has resized the connection to adapt to transmission problems or the application layer may initiate a connection size change to accommodate greater data throughput. To illustrate the process, shown in FIG. 16, of message passing for the application layer initiated case, the base transceiver application layer issues an apRESIZE message to the adaptation layer. The adaptation layer then issues an aRESIZE command to the RF layer (116). The RF layer arranges for the RF link resize by messaging with the peripheral by sending the btRESIZE_CONNECTION message 118.

The RF layer of the peripheral then informs the peripheral higher layers of the change using the rRESIZE and adRESIZE messages upward to request the resize 120 and then apRESIZE and aRESIZE commands back down to the peripheral RF layer 122. Upon receiving the upper layer confirmation, the peripheral RF layer sends the pRESIZE_CONNECTION back to the base transceiver to confirm the peripheral is ready for the resizing operation. The response packet is adapted to the resize operation 124. The RF layer then confirms the operation is complete by issuing a rRESIZE message 126 to the adaptation layer and the adaptation layer issues an adRESIZE message to the application layer to confirm the change. The resized connection may then be used 128. These types of situations are seen as circular references in the “EXPECTED RESPONSE” column and reflect message flows for the base transceiver and peripherals that are mirror images of each other in certain cases.

TABLE 2
RF to Adaptation Messages

| MESSAGE | PURPOSE | PARAMETERS | EXPECTED RESPONSE |
|---|---|---|---|
| aOPEN_CONNECTION | Adaptation layer request the | Message ID | RHAVE_CONNECTION |
| | RF layer to open a peripheral | | |
| | connection. For the base | | |
| | transceiver this initiates a | | |
| | btJOIN at the RF layer. | | |
| rHAVE_CONNECTION | RF layer confirms to | Message ID, expected packet | None |
| | adaptation layer that a | length (for buffer sizing), host | |
| | connection is established. | type, firmware version, protocol | |
| | | version | |
| RCHANGE_CHANNEL | RF layer informs the | Message ID, success flag, | None |
| | adaptation layer of a channel | connection(s) lost flags. | |
| | change (frequency hop). | | |
| | Connection lost flags are | | |
| | used by higher layers to turn | | |
| | off link status indicator lights. | | |
| ACLOSE_CONNECTION | Adaptation layer request the | Message ID, short mating | RCLOSE_CONNECTION |
| | RF layer to close a | number, save connection | |
| | connection. Initiated by base | settings request | |
| | transceiver. | | |
| rCLOSE_CONNECTION | RF layer informs the | Message ID, short mating | None |
| | adaptation layer that a | number, error code | |
| | connection is closed. | | |
| aLINK_STATUS | Adaptation layer requests link | Message ID, short mating | RLINK_STATUS |
| | status information from the | number | |
| | RF layer. | | |
| rLINK_STATUS | RF layer sends link status | Message ID, short mating | None |
| | information to the adaptation | number, link quality | |
| | layer | | |
| aSEND_DATA | Adaptation layer requests RF | Message ID, short mating | None, unless data sent |
| | layer to send data. | number, message length, data | contains an encapsulated |
| | | container | adaptatation layer |
| | | | message. |
| rHAVE_DATA | RF layer sends data to the | Message ID, short mating | None, unless data sent |
| | adaptation layer. | number, message length, data | contains an encapsulated |
| | | container | adaptatation layer |
| | | | message. |
| ARESET | Adaptation layer to RF layer | Message ID, short mating | rRESET |
| | request to reset a peripheral. | number | |
| | Reset is coordinated by the | | |
| | application layer. | | |
| RRESET | RF layer to adaptation layer | Message ID, short mating | aRESET |
| | request to reset a peripheral. | number | |
| ARESIZE | Adaptation layer to RF layer | Message ID, short mating | rRESIZE |
| | resize a connection. | number, new connection size | |
| RRESIZE | RF to adaptation layer resize | Message ID, short mating | aRESIZE |
| | a connection. | number, new connection size | |
| AREMOTE_TEST | Adaptation layer to RF layer | Message ID, test type (BT only), | rREMOTE_TEST |
| | remote testing. | message length (P only), test | |
| | | data results (P only), short | |
| | | mating number | |
| RREMOTE_TEST | RF to adaptation layer | Message ID, test type (P only), | aREMOTE_TEST |
| | remote testing. | message length (BT only), test | |
| | | data results (BT only), short | |
| | | mating number | |

Adaptation layer 112 to adaptation layer 112 messages are used for devices to share device feature information. The type and format of data collected by a peripheral is converted to a form usable by the host and vice versa. Adaptation layer messages also request the RF layer 110 to close a connection and support the upgrade process. These messages always come in pairs and are always originated from the base transceiver. The table below shows a representative example of adaptation to adaptation messages needed to support RF layer operations. The exact format and content of these messages changes depending on the application type supported. The application described is for a game peripheral. These messages are carried as a payload of the RF layer data carrying messages, btPOLL_DATA and pPOLL_DATA. Adaptation layer messages are prefixed by “bt” for those originated at the base transceiver and prefixed by “p” for those originated at the peripheral.

TABLE 3
Adaptation to Adaptation

| MESSAGE | PURPOSE | PARAMETERS | EXPECTED RESPONSE |
|---|---|---|---|
| BtENUMERATE | The base transceiver | Message ID, feature set request, | pENUMERATE |
| | requests the peripheral to | sequence number, short mating | |
| | describe its feature set. This | number | |
| | allows adaptation to new | | |
| | controller types and new | | |
| | controller features. All or | | |
| | selected feature sets may be | | |
| | requested. | | |
| PENUMERATE | The peripheral describes its | Message ID, short mating | None |
| | feature set to the base | number, sequence number, | |
| | transceiver. | maximum sequence count, | |
| | | message length, feature list | |
| BtCONFIGURE | The base transceiver | Message ID, short mating | pCONFIGURE |
| | requests the peripheral to | number, sequence number, | |
| | configure its feature sets to | maximum sequence count, | |
| | match host interface | message length, feature | |
| | characteristics. This | configuration list | |
| | message may be sent in | | |
| | several parts. | | |
| PCONFIGURE | The peripheral confirms the | Message ID, short mating | None |
| | configuration process and | number, peripheral hardware ID. | |
| | provides the hardware | | |
| | revision number of the | | |
| | peripheral electronics | | |
| | (upgrade version | | |
| | identification purposes) to the | | |
| | base transceiver. | | |
| BtGOODBYE | The base transceiver sends | Message ID, short mating | None |
| | this message to the | number, save settings flag | |
| | peripheral as part of a close | | |
| | connection sequence as | | |
| | initiated by the peripheral. | | |
| PGOODBYE | The peripheral sends this | Message ID, connection | btGOODBYE |
| | message to the base | selection switch flag, short | |
| | transceiver to request it to | mating number, save settings | |
| | originate the close | flag | |
| | connection process e.g. | | |
| | when the connection | | |
| | selection switch has been | | |
| | pressed. | | |
| BtUPGRADE | The base transceiver sends | Message ID, short mating | pUPGRADE |
| | this message to the | number, peripheral hardware ID, | |
| | peripheral to initiate an | firmware version, image length | |
| | upgrade of the peripheral's | (image to follow) | |
| | firmware. btPOLL_DATA is | | |
| | used to send upgrade | | |
| | information. | | |
| PUPGRADE | The peripheral sends this | Message ID, short mating | None |
| | message to the base | number, peripheral hardware ID, | |
| | transceiver to acknowledge | error code | |
| | the upgrade request. If | | |
| | hardware or software version | | |
| | numbers do not match, the | | |
| | attempt is rejected. | | |

Application layer to adaptation layer messages occurs between the application layer 114 and the adaptation layer 112. The application uses this interface to communicate with lower protocol layers. These messages are used to request connection changes, to send and receive data to the RF layer for transmission, to facilitate testing and system upgrades. The table below shows a representative example of application to adaptation messages needed to support RF layer operations. The exact format and content of these messages changes depending on the application type supported. The messages shown are for a game peripheral application. Messages prefixed by “ap” are originated at the application layer and messages prefixed by “ad” are originated at the adaptation layer.

TABLE 4
Application to Adaptation Layer

| MESSAGE | PURPOSE | PARAMETERS | EXPECTED RESPONSE |
|---|---|---|---|
| ApOPEN_CONNECTION | Application layer requests the | Message ID, host interface | adHAVE_CONNECTION |
| | adaptation layer to open a | information (BT only) | |
| | peripheral connection. For | | |
| | the base transceiver this | | |
| | initiates a btJOIN at the RF | | |
| | layer. | | |
| AdHAVE_CONNECTION | Adaptation layer informs the | Message ID, RF port used | None |
| | application layer that the | (corresponds to connection light), | |
| | previous connection request | peripheral type, connnection | |
| | is complete. | state, host interface information | |
| | | (BT only), peripheral version | |
| | | numbers. | |
| AdCLOSE_CONNECTION | Adaptation layer informs the | Message ID, error code, RF port | None |
| | application layer that a | used (BT only) | |
| | connection (one of several for | | |
| | the BT) is closed. | | |
| ApGOODBYE | The peripheral application | Message ID, connection | adCLOSE_CONNECTION |
| | layer requests the adaptation | selection switch flag (P only), RF | |
| | layer to begin the close | port used (BT only) | |
| | connection sequence when | | |
| | the connection selection | | |
| | switch is pressed - manual | | |
| | RF connection change. | | |
| apLINK_STATUS | Application layer requests the | Message ID, RF port used (BT | adLINK_STATUS |
| | adaptation layer to obtain the | only) | |
| | link status. | | |
| adLINK_STATUS | Adaptation layer informs the | Message ID, RF port used (BT | None |
| | application layer about the | only), link quality | |
| | link status check results. | | |
| AdCHANGE_CHANNEL | Adaptation layer informs the | Message ID, channel change | None |
| | application layer about the | pass/fail flag, peripherals found. | |
| | results of a frequency hop | | |
| | e.g. any lost peripherals | | |
| | declared and the application | | |
| | layer turns off corresponding | | |
| | connection light. | | |
| ApSEND_BUFFER | Application layer requests | Message ID, RF port used (BT | None |
| | adaptation layer to send data | only), peripheral interface & host | |
| | to lower layers for | interface information (to direct | |
| | transmission. Need to send | adaptation layer data formating | |
| | to a targeted peripheral for | so the output is usable by the | |
| | the base transceiver case. | host or peripheral) | |
| AdHAVE_BUFFER | Adaptation layer informs the | Message ID, RF port used (BT | None |
| | application layer that new | only), peripheral interface & host | |
| | data has been sent from a | interface information | |
| | lower layer. | | |
| ApRESET | Application layer command to | Message ID, RF port used (BT | adRESET |
| | the adaptation layer to initiate | only) | |
| | a reset. | | |
| AdRESET | Adaptation layer command | Message ID, RF port used (BT | apRESET |
| | used during reset. RF port | only) | |
| | number used to turn off | | |
| | indicator lights on BT. | | |
| ApRESIZE | Application layer asks the | Message ID, RF port used, host | adRESIZE |
| | adaptation layer to resize a | information (BT only), new | |
| | connection. Request gets | connection size | |
| | passed to RF layer. | | |
| AdRESIZE | Adaptation layer informs the | Message ID, RF port used, host | apRESIZE |
| | application layer about resize | information (BT only), new | |
| | event. This is a confirmation | connection size | |
| | in the BT case. | | |
| ApREMOTE_TEST | Application layer test | Message ID, test type (BT only), | adREMOTE_TEST |
| | message to the adaptation | data length (P only), test data | |
| | layer for a remote peripheral. | results (P only), RF port used | |
| AdREMOTE_TEST | Adaptation layer test | Message ID, test type (P only), | apREMOTE_TEST |
| | message to the application | data length (BT only), test data | |
| | layer for a remote peripheral, | results (BT only), RF port used | |
| ApUPGRADE | Application layer to | Message ID, peripheral hardware | adUPGRADE |
| | adaptation request for | ID, firmware version, image | |
| | upgrade notification. | length, RF port used (BT only) | |
| AdUPGRADE | Adaptation layer to | Message ID, peripheral hardware | apUPGRADE |
| | application layer request for | ID, firmware version, image | |
| | upgrade notification. | length, RF port used (BT only) | |

Continuing with the system description as shown in FIG. 4a, the controller 18 is connected via conventional communication links to digital and analog interfaces to support host and environment interfaces (e.g. signal lights) in the base transceiver 12 and user and environment input/output in the peripheral 14. FIG. 4b and FIG. 4c show the controller as it is configured as a peripheral and as a base transceiver for a gaming application. The following interfaces are used: external memory interface 130, DSP serial interface (future capability to add processing capacity as required) 132, both through bus 133, RF baseband interface 134 through bus 133, analog to digital interface

and a general purpose digital interface 137, test interface 138 for connection to a debug system 140, host interface 142 (for example, a game console interface such as a direct parallel connection, USB interface, SPI or proprietary host-defined interface), power and clock input 144, 146 for an external oscillator and clock. The peripheral is connected to various input devices at 148 such as game controller keys, joysticks and to output devices at 150 such as “rumble” motors and a signal connection light. For the peripheral configuration there is no host and this interface is not used. The design of each of these interfaces is dependent on the design of the device being interfaced e.g. the type of RF subsystem used or the type of host device interfaced.

The controller 18 is also used to convert raw data to and from the host/environment or RF transceiver. The controller firmware must be changed on a per case basis to accommodate the proprietary interface specifications of a given host device. The RF transceiver interface control functions are designed to accommodate the RF subsystem chip interface specifications of a given vendor e.g. Microlinear or Texas Instruments chip-sets as mentioned above. The RF baseband data interface 134 carries the raw digital data coming and going to the RF subsystem 16. The controller 18 directs the RF subsystem 16 to perform frequency scan operations for signal characterization purposes and performs various synchronization operations and coding functions to lock onto baseband data signals and ensure their reliable transmission.

Frequency scanning functions are performed using the receive signal strength indicator (RSSI) function, as seen in FIG. 4a, as is found on many RF chipsets. The controller 18 directs the RF chipset to tune to a given center frequency and then RSSI measures the signal strength within the receiver's channel envelop at that center frequency. The envelop form is determined by the receiver's intermediate frequency (IF) filtering characteristics. FIG. 10 shows such a receiver channel envelop. The signal strength sample can be taken in as little as 100 microseconds for some RF subsystem types. This allows a base transceiver or peripheral to scan a broad range of channel frequencies in a short interval.

The controller 18 uses a direct sequence spread spectrum coding method to provide an error correction capability. The controller 18 is implemented to support multiple parallel threads or processors. Two of these threads are dedicated to such baseband processing. In order to increase the robustness of the system and to assist with the synchronization function, a well known direct sequence spreading code method is preferably used, although other coding methods might also be used in a similar fashion. When a buffer of raw data is being prepared for transmission, sequences of 2, 4 or more bits are mapped to a set of 16 bit spreading codes. The system transmits codes to represent actual signal bits over the RF link to give the transmitted signal several desirable characteristics. Codes are chosen based on selection conditions to maximize the “Hamming distance” between elements within a code set, to have zero D.C. offset, to support defined bit run-length characteristics, and to support error-correction. Hamming distance is defined as the number of bit differences found when the logical exclusive-OR function is performed on any two codes from a code set. A Hamming distance of 3 is desired between any two codes in a code set and a frame start code should preferably have a Hamming distance of 8 from an alternating 0,1 preamble sequence used for synchronization purposes. The larger the code distance, the easier it is to differentiate codes at the receiving end even if they are partially corrupted.

At the receiving end, received codes are compared against known spreading codes and converted back into the original bit sequence. Because code types are chosen to have known bit differences, the received code, even if 1 or more bits are corrupted, can be matched successfully to a reference code and decoded back to the original bit sequence. Any code set satisfying the above selection conditions can be used by the system. A set consisting of 4, 16 or more, 16 bit spreading codes is required to represent any 2, 4 or longer bit sequence respectively.

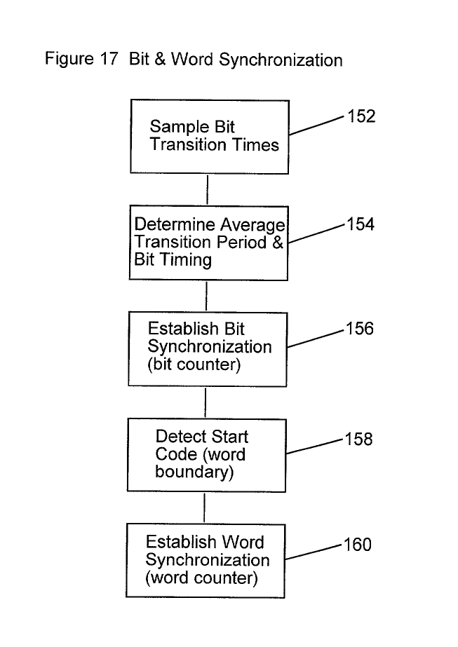

As shown in FIG. 17, the controller 18 performs bit and frame synchronization functions as each new packet arrives. All packets transmitted by the RF system are prefixed by a preamble sequence followed by a start code (217B HEX) which is the first element of a packet header. The preamble sequence is a series of up to 80 zeros and ones used to establish the packet bit and then frame timing and to train the RF receiver's D.C. offset parameters. When a new packet preamble sequence is detected by the controller, it begins to sample the incoming bit stream at a rate which is at least 8 times the frequency of a single bit time. During the preamble, multiple signal level samples are taken by the controller to detect bit transition times and hence the logical transition time and period of the incoming bit stream 152. A window, containing 16 transitions, is analyzed by the controller. The transition timing, bit period and relative 0/1 timing is determined by taking the average of all transitions from the 16 bit sample 154. This process only “locks” onto a bit stream when 16 zeros and ones in a row are detected. A bit counter having a count value that repeats at the center of every transmitted bit is initialized and run continuously 156. This timer is used to control when the logical value of the raw bit stream is sampled and recognized. Using the output of the sampling process, the repeat count value of this counter can be adjusted dynamically to adjust for bit timing variations.

Once bit timing is established the beginning of the packet frame and frame boundaries are determined. As each new bit sample is read in the preamble, a 16 bit word, consisting of the most recent 16 bits is read and decoded. The first 16 bit code after the preamble sequence is a START Code 158. This code is chosen so that it has a 8 bit difference (Hamming Distance) from the preamble sequence so that even with severe signal degradation, the first word of the packet can be easily decoded. This first word is used to set up frame or word synchronization in the message packet 160. A word counter with a period corresponding to the time taken to transmit a single word is initialized and is used to decode packets contents on their word boundaries.

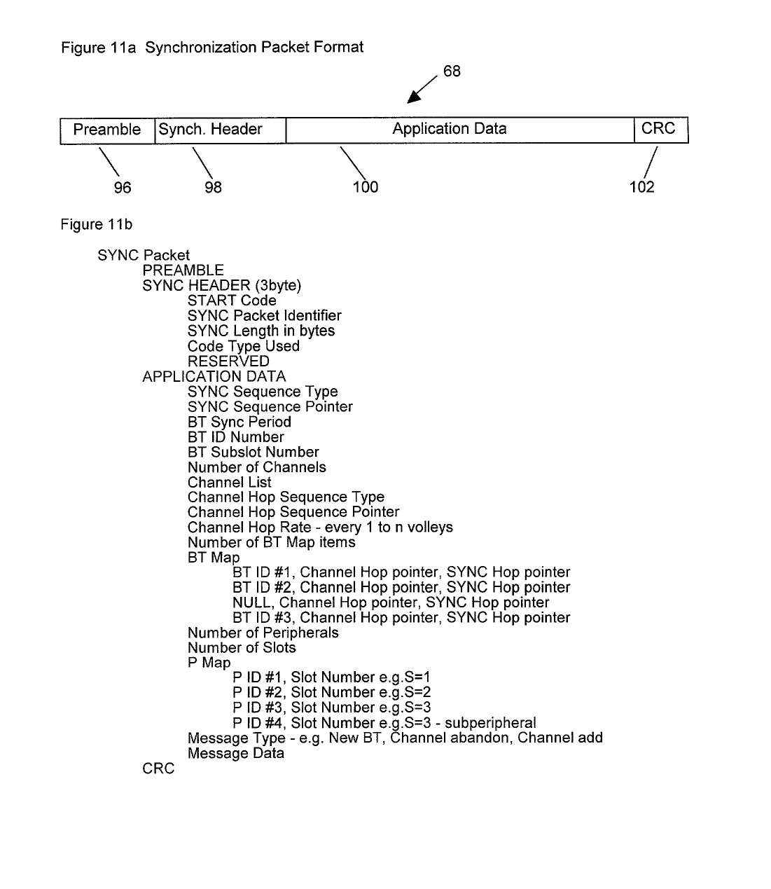

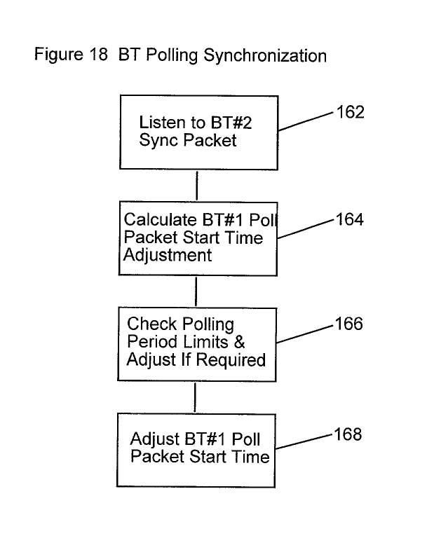

Base transceivers 12 and peripherals 14 use bit and word synchronization to lock onto, read and derive timing information from RF packet transmissions from an arbitrary system RF transceiver. As shown in FIG. 18, a first base transceiver (BT #1) can listen 162 to the synchronization packet from a second base transceiver (BT #2) that is in range, calculate a start time adjustment 164, check polling period limits if required 166 and adjust 168 its polling packet timing to occur nearly at the same time as the other base transceiver. A polling-period counter in each base transceiver controls the polling volley period length. This counter can be adjusted incrementally as required. A first base transceiver detects the start time of the START Code in the synchronization packet (see FIG. 11b) of a second base transceiver and adds a known time offset to calculate the poll packet start time of the second base transceiver. An offset, used to adjust the polling-period counter of the first base transceiver, is then preferably derived from an average of the first base transceiver's polling packet start time and the start time of the second base transceiver, but may be any calculated amount that prevents overshoot and timing instability. Whatever solution is used, the adjustment moves toward a target value, and does not attempt to hit the target in one step. As a first base transceiver and a second base transceiver compare and adjust their polling packet start times over time, these times move toward each other. In order to guarantee the polling response time of the system, the polling-period counter is not allowed to vary beyond a defined tolerance of the 16.67 msec system-defined polling time. The appropriate value of this tolerance and polling time is application specific. Also in a given polling volley, peripherals respond in time slots that are an agreed delta time away from the Start Code of the base transceiver's polling packet.

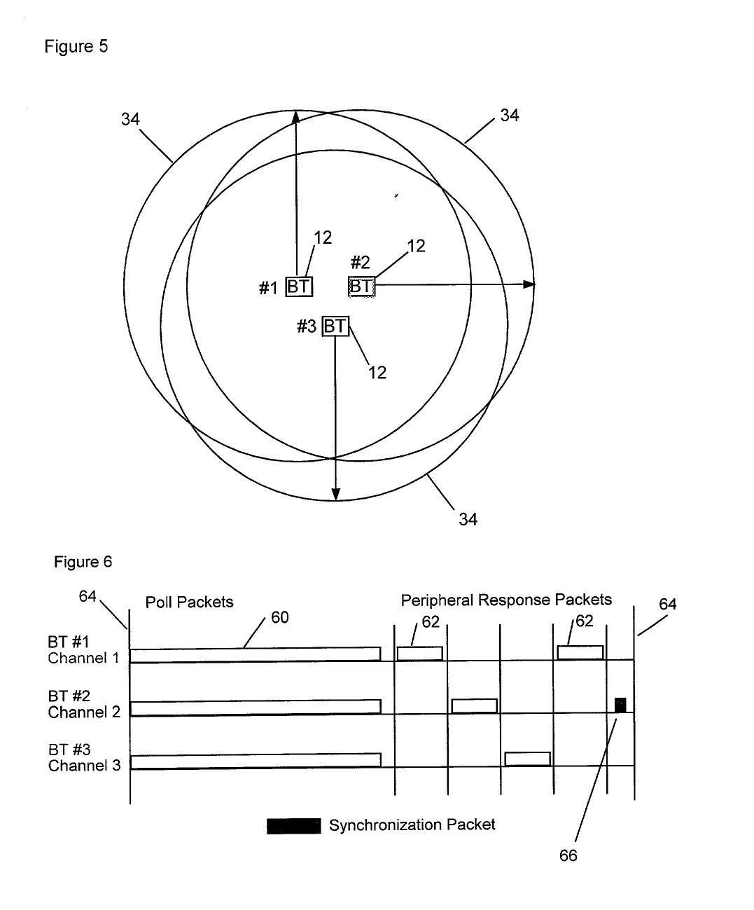

In a given local area, systems of hosts 10, base transceiver 12 and associated peripherals 14 coexist. FIG. 5 illustrates an example of overlapping RF domains 34 as represented by the transmission footprint of each base transceiver.

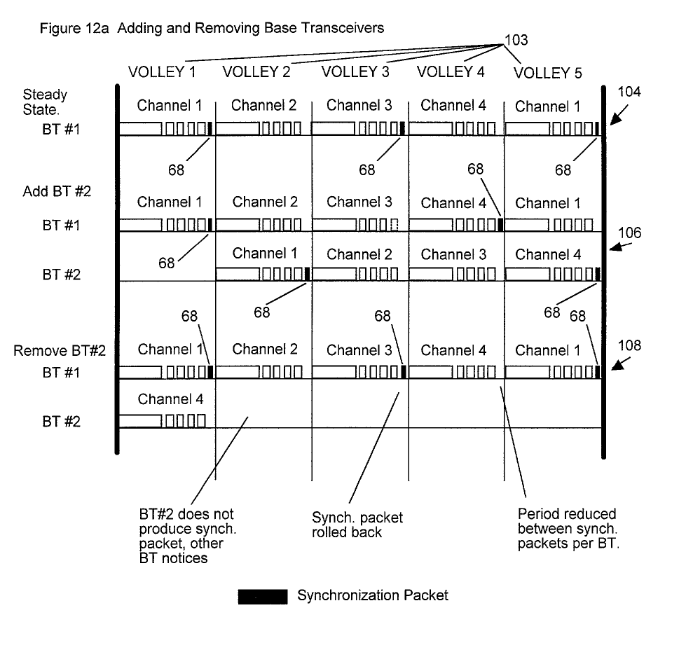

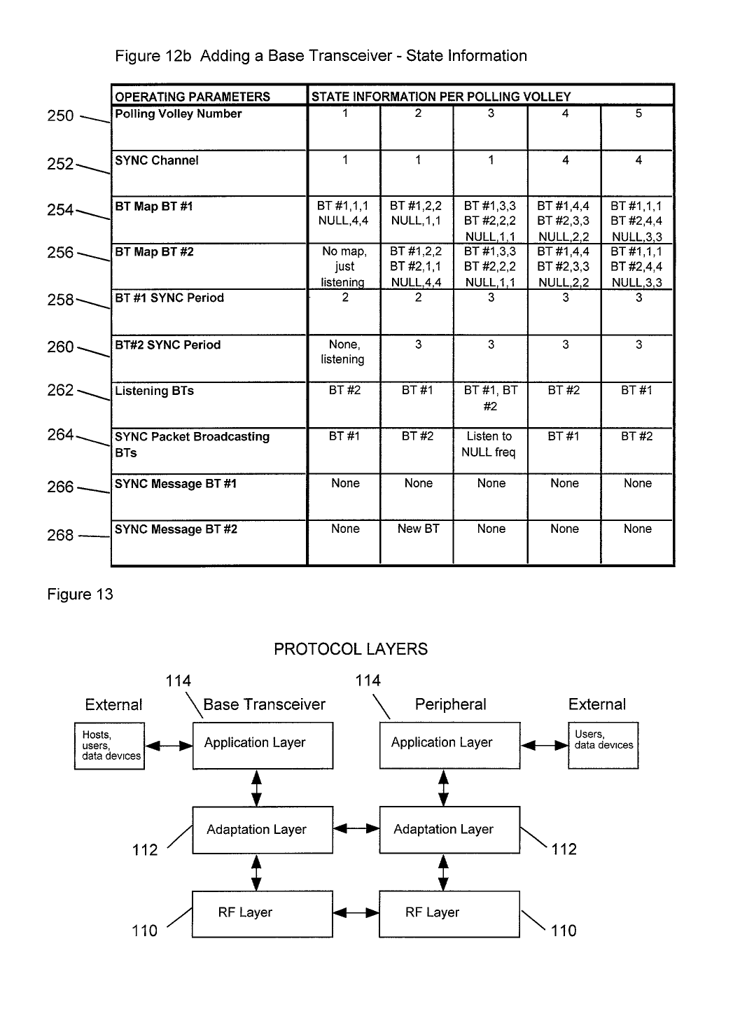

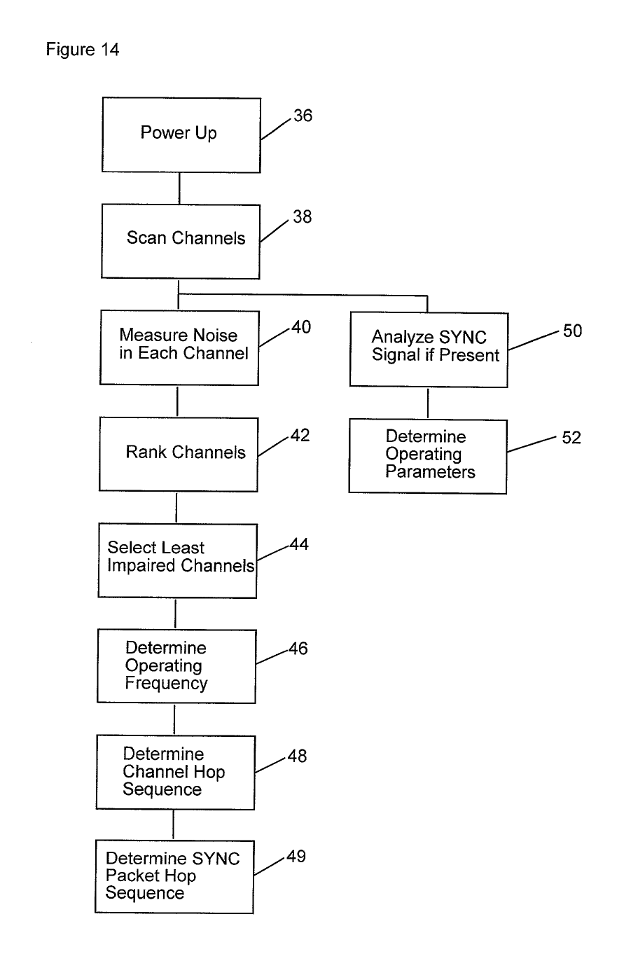

Referring to FIG. 14, as a base transceiver 12 powers up 36 the application layer performs a self-test and then waits for a random interval of several hundred milliseconds. This waiting interval staggers the RF activation of two or more base transceivers that are connected to a single host system. Following this, the application layer starts the RF layer (using the apOPEN_CONNECTION and then aOPEN_CONNECTION messages). The RF layer characterizes the RF spectra and searches for other base transceivers 12 in its RF operating range using RSSI hardware as described above. The base transceiver 12 looks for free RF channels and RF channels used by other base transceivers 12 (38) by scanning the available channels incrementally. The base transceiver 12 also characterizes the noise present on available channels 40 and ranks the channels in terms of impairment 42. If the base transceiver is the first base transceiver to be activated in a given RF operating range, it selects sufficiently unimpaired channels for use 44 and chooses a starting operating frequency 46 and hopping sequence 48 corresponding to the number of usable channels. The preferred hopping sequence is a pseudo random sequence (although sequential sequences can be used and are used in the examples for simplicity) the length of which depends on the number of usable channels e.g. for a system with 4 usable channels a predefined sequence CH1, CH3, CH2, CH4 can be used based on the number of usable channels, although longer sequences that are multiples of the number of usable channels are also possible. In order to support 16 devices in a common RF operating range at least 4 channel frequencies are required. If 4 good channels are not available, impaired channels are used if possible in order of least signal impairment until 4 channels are chosen i.e. there are enough channels above a certain minimum threshold such as a signal to noise ratio of 30 dB. The value of this threshold will depend on the application supported and how many errors in transmission (inverse of the grade of service) can be tolerated. The first base transceiver also chooses a predefined frequency hopping sequence for the synchronization packets based on the number of usable channels 49. The synchronization packet hopping sequence type can be the same (same start value, same length, same hop sequence), as is shown in the example in FIG. 12, or different from the first base transceiver poll and response packet hopping sequence type (same or different start value, same or different length, same or different hop sequence) depending on the desired characteristics for the synchronization packet versus the poll and response packets as determined by the designer. A separate pointer is also assigned for the synchronization packet hopping sequence that can be the same or different than the pointer for the polling volley frequency hopping sequence.

The RF subsystem can also support variable center frequencies, hence the channel center frequencies can be predefined, or picked at the time of the first base transceiver's noise scan to avoid areas of high sustained noise. The number of possible channel center frequencies depends on the RF subsystem channel tuning resolution and for a given device it can be represented by an integer value. Information relating to the number of channels, channel selection and channel hop sequence is broadcast in the synchronization packet.

From the channel scan 38, when there is at least one base transceiver in the system, the new base transceiver 12 determines that other base transceivers exists and locks onto and analyzes sync signals from another base transceiver 12 (50), to determine its operating parameters such as when to start polling volleys to its associated peripherals 14 (52). These parameters are determined by analyzing the timing and content of another base transceiver's RF transmission headers and synchronization packets.

After power up, the transmission channel frequency for each base transceiver channel hops in a defined sequence and with a defined hopping rate. A hopping rate of 60 hops per second is supported (channel change once per polling volley), although higher rates are possible by reducing the period of the polling volley. Frequency hopping is known in the art, and any of many known hopping patterns may be used in accordance with spread spectrum techniques.

Channels used by the system are continuously scanned for noise, one or a few channels at a time during operation, and are automatically not used if they cannot support any transmissions reliably. The base transceiver sends a btSCAN_CHANNEL message to request a channel scan and peripheral acknowledges with a pSCAN_CHANNEL message. On a subsequent polling interval, the base transceiver requests the results using the btSCAN_RESULTS message and they are provided by peripheral using the pSCAN_RESULTS message. In noise situation system operation degrades gradually and the impact of this degradation is shared across all base transceivers 12 as they hop through the noisy channel or channels.

When degradation occurs the transmission errors can be passed uncorrected, data can be retransmitted, coding methods changed, operating channels dropped, or data rates can be dynamically decreased to increase the accuracy of a noisy channel.

Each base transceiver 12 uses a hopping sequence that is non-overlapping with hopping patterns of all other base transceivers 12 in the local area. The base transceiver 12 can preferably direct the frequency hops of its attached peripherals 14 using the btCHANNEL_CHANGE and pCHANNEL_CHANGE commands or they can follow the base transceiver 12 automatically in a known hopping pattern.

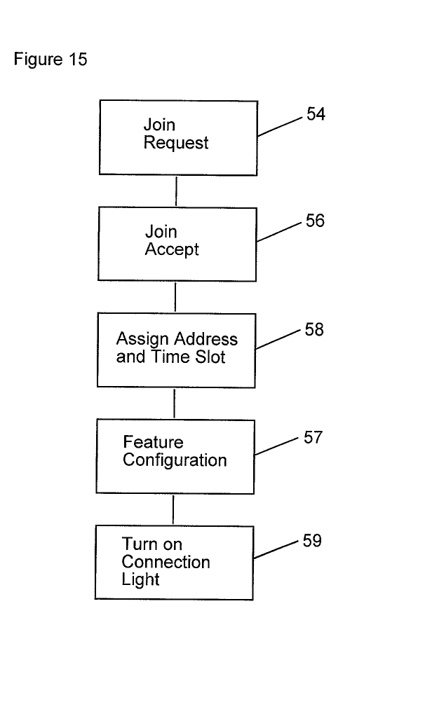

Referring to FIG. 15, following power up the base transceiver 12 begins polling for peripherals 14 asking them to become associated with the base transceiver 12 by the wireless link. Such an association is made by a join request 54 (btJOIN message) by the base transceiver 12, followed by a join acknowledge (pJOIN_message) from the peripheral 14 to tell the base transceiver that it is interesting in being associated. By convention this peripheral response is provided in the last unoccupied peripheral time slot in the polling volley. Next the base transceiver issues a btJOIN_ACCEPT message and the peripheral responds with a pJOIN_ACCEPT message, resulting in the exchange of full address and other information 56. At this point of connection initialization a short address, called a short mating number, is assigned to the peripheral's connection to the base transceiver and is used thereafter for communications. The peripheral is also assigned a time slot in the polling volley 58 and from that point onward the peripheral 14 communicates with the base transceiver 12. There is a chance that a second peripheral may have simultaneously responded to the btJOIN message with another pJOIN message. If this has occurred and this second peripheral beat the first peripheral in joining to the base transceiver, the information provided by the btJOIN_ACCEPT message will be for the second peripheral. If the first peripheral detects this situation, it stops its join process and waits a random interval before trying again i.e. responding to a new btJOIN message. This forced wait prevents join conflicts between competing peripherals.

A special situation can exist during initial peripheral connection, relating to whether the peripheral is of a sub-peripheral type. A peripheral can operate by itself and occupy its own time slot, can support a sub-peripheral, or can be a sub-peripheral only. Using the pJOIN message peripheral type parameter, the presence of a sub-peripheral is detected by the base transceiver. If a peripheral exists to support this sub-peripheral, the base transceiver assigns the sub-peripheral to an available sub-slot of the peripheral's response time slot and adds a sub-peripheral header/data field to its polling packet to address the new sub-peripheral. If no peripheral can support the sub-peripheral, the connection attempt is rejected by the base transceiver. In the btJOIN_ACCEPT message the pass/fail flag is set to fail. The sub-peripheral then responds with a pCLOSE_CONNECTION message to end the connection attempt.

Following connection set up, a list of features supported by the peripheral (e.g.number and type of buttons, joysticks, data ports) are sent to the base transceiver (btENUMERATE base transceiver message followed by pENUMERATE peripheral message) and this is compared with host requirements 57. A set of peripheral features to be used by the host is selected by the base transceiver. The base transceiver then sends configuration information to the peripheral telling it how it is to supply and receive information from the host (btCONFIGURE base transceiver message followed by a pCONFIGURE message from the peripheral). The base transceiver and peripheral adaptation layers then send adHAVE_CONNECTION messages to their respective application layers to inform them of the new connection. These layers can then perform the appropriate actions such as turning on their respective connection lights 59, notifying a host that a new peripheral has joined in the case of the base transceiver, and beginning to sample and aggregate input interface information in the case of the peripheral.

If the peripheral later wants to leave it requests the connection be closed or simply leaves and the base transceiver closes the connection after several polling cycles in which no response is found from the peripheral. While unused time slots remain, multiple peripherals may be added or drop off using this method.

The exact time slot assignment given to a peripheral is determined by the base transceiver. Time slots may be assigned in a sequential first come, first served basis, assigned in coordination with the time slots assigned to neighboring base transceivers, or assigned by an algorithm such as a generated pseudo random sequence. Time slots should not overlap with each other.

For example, as shown in FIG. 6, in a system of base transceivers with only a few peripherals, time slots can be assigned so that all peripherals in time and on different frequencies associated with different base transceivers only respond in non-overlapping time slots. In FIG. 6, a first base transceiver begins a polling volley 60 and then listens for responses 62 from peripherals 14 in the later part of a time slot schematically represented as a time interval bounded by the vertical bars 64. Corresponding polling volleys of additional base transceivers #2 and #3 are shown. Base transceiver #2 is also shown as transmitting a sync signal 66, which the other base transceivers 12 listen for. Each time period comprising a specific polling volley and corresponding responses may be called a polling cycle.

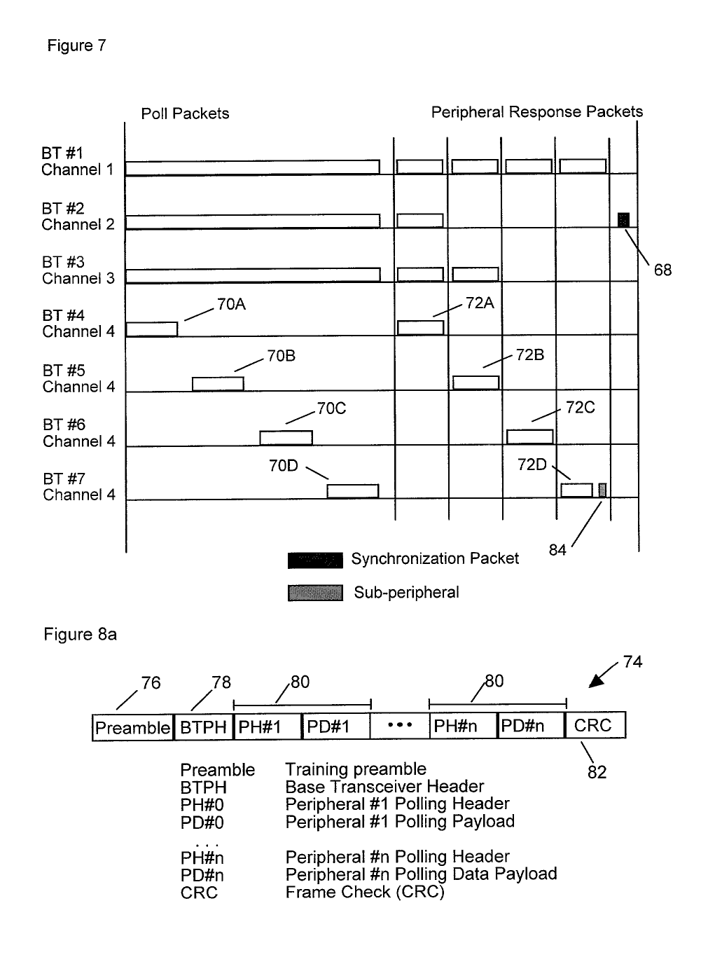

Examples of different polling volleys for multiple base transceivers 12 located in the same RF domain are illustrated in FIG. 7. The volley for base transceiver #1 (BT #1) shows a base transceiver system where all the peripheral time slots have been assigned and are used by respective peripherals communicating with the base transceiver #1. The volley for base transceiver #2 (BT #2) has one connected peripheral, different from the peripherals communicating with the base transceiver #1. A synchronization packet 68 is also shown. Only one such packet 68 is associated with each polling volley for a system of base transceivers having overlapping frequency domains. The sync packet 68 is transmitted by one base transceiver and used by all other base transceivers to adjust the start time of their polling volley as described above. Only one base transceiver transmits a sync packet during the time span associated with a polling volley. Each base transceiver transmits a sync packet in turn. Generally, a base transceiver transmits a sync packet each n+1 polling volleys, where n is the number of base transceivers transmitting in the domain. This leaves one polling volley without a sync packet each n+1 polling volleys. That polling volley may be used by a base transceiver seeking to commence transmitting in the domain. When a base transceiver is added or a base transceiver stops transmitting in the domain, the other base transceivers adjust their sync packet transmissions accordingly to leave one polling volley without a sync packet in each n+1 polling volleys.

The volley for base transceiver #3 (BT#3) has two connected peripherals. Base transceivers 4, 5, 6 and 7 (BT#4, 5, 6, 7) are of a simpler type than base transceivers 1, 2, 3 and hence have a short poll packet and typically support only a single peripheral. Base transceivers 4, 5, 6,and 7 efficiently use a single channel thus conserving spectrum by time division multiplexing multiple poll/response pair signals together. As indicated in FIG. 7, the base transceivers 4-7 transmit sequentially, one at a time on a single channel, during an initial polling volley, with each base transceiver 4-7 communicating with a different one of four peripherals using packets 70A, 70B, 70C and 70D. The peripherals then respond in order with their response packets 72A, 72B, 72C and 72D in a later part of the time period associated with the polling volley.

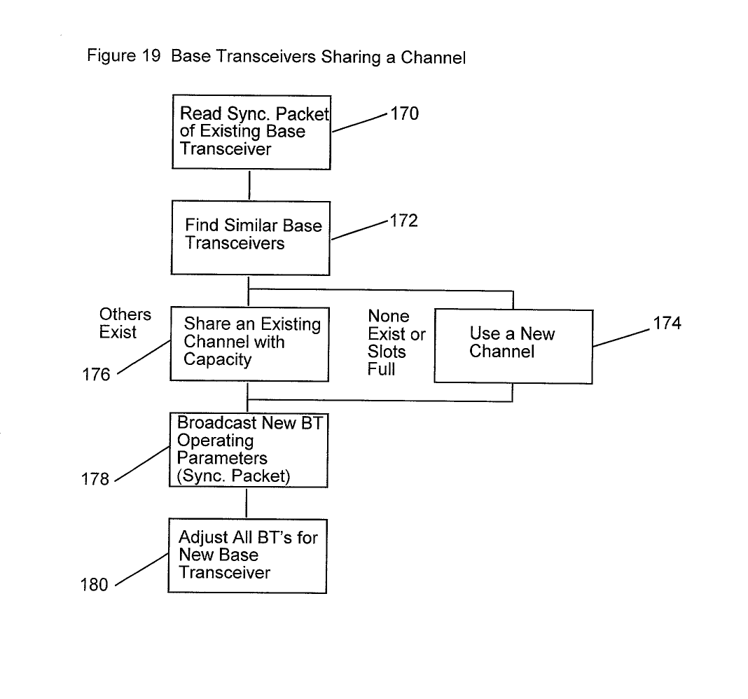

As shown in FIG. 19, the configuration process to support base transceivers of type 4 to 7 (FIG. 7) requires an additional degree of coordination. When this type of base transceiver starts up it listens to a given frequency until it finds a poll packet and a synchronization packet 170. From the synchronization packet (described below in more detail and shown in FIG. 11b) it preferably discovers the existence of other base transceivers of its type from the base transceiver identification (ID) number map (BT Map) contained in the synchronization packet 172. The last four bits of the base transceiver ID number identify the number of supported peripherals. Base transceivers that support one peripheral have a value of 0 and those that support four peripherals have a value of 3. This identifier could also be contained as a separate parameter in the synchronization packet. Also the channel hop pointer associated with each base transceiver in the base transceiver map for base transceivers sharing a common frequency is the same. Using this information the new base transceiver determines if base transceivers supporting a single peripheral exists. If none do or an existing channel with multiple such base transceivers is fill, it uses a new starting frequency in the frequency hopping method used by the system 174. If other base transceivers of the single peripheral type exists, the new base transceiver of this type selects a new unused base transceiver slot and peripheral slot 176. It then broadcasts this information in its synchronization packet at the appropriate polling volley interval 178 so that other base transceivers are aware, update their corresponding base transceiver maps, and avoid using these time slot assignments 180. Such a method may be used for base transceivers sharing a common frequency with more than one peripheral where sufficient time slots exist to support multiple such time division multiplexed base transceivers.

Although the figure illustrates base transceivers supporting up to four peripherals or only one peripheral, the number of peripherals responding per base transceiver and the number of poll/response pairs that are multiplexed can be varied in numerous configurations to suit the given application.

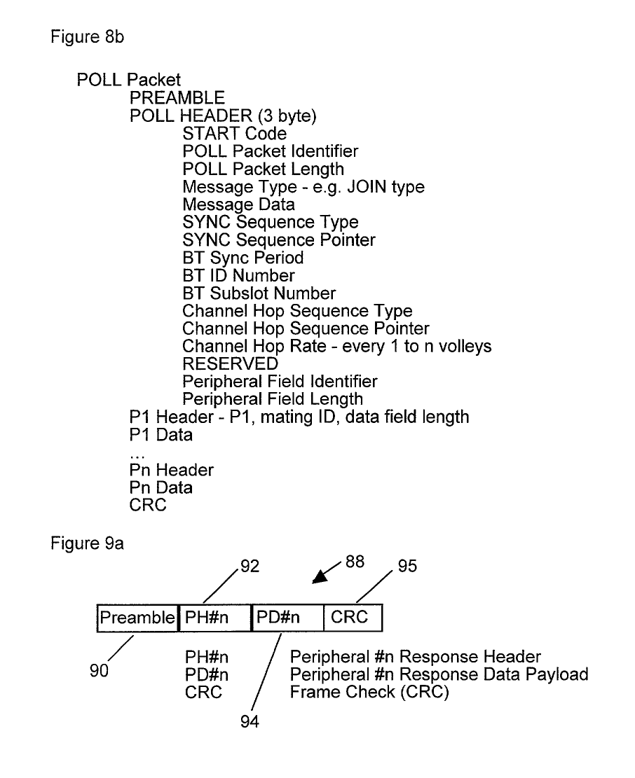

Regardless of the polling configuration, the base transceivers 12 each send a polling packet 74 having the format shown in FIG. 8a. This packet 74 contains a preamble 76, an overall base transceiver header 78 providing overall system defined control functions and peripheral poll sub-packets 80, each with a header and payload, addressed to each of the connected peripherals 14. Join and other control messages are contained in the base transceiver header or if too large can be inserted after the peripheral poll sub-packets. The preamble is used to train the peripheral receiver's bit timing and D.C. offset parameters. A frame check 82 terminates the packet 74.

FIG. 8b shows a detailed breakdown of a representative base transceiver polling packet for a wireless game peripheral application. The header, like all system packets starts with a START Code to facilitate word boundary alignment. The POLL Packet Identifier and POLL Packet Length identify this packet to be of the POLL type and of the length indicated. The Message Type and Message Data fields support carrying global type messages such as those used during the initial connection formation (e.g. btJOIN and btJOIN_ACCEPT messages). The base transceiver SYNC Sequence Type allows the synchronization packets to follow a separate frequency hopping sequence from the base transceiver polling volley frequency hopping sequence (Channel Hop Sequence Type). The SYNC sequence pointer shows where in the hop sequence the sync signal lies. The BT SYNC Period defines the number of polling volleys between synchronization packets for a given base transceiver. The BT ID Number is the base transceiver's unique identification number. The BT Subslot Number is used to denote the subslot within which a base transceiver supporting less than 4 peripherals indicates the subslot in the poll packet time interval during which it broadcasts a polling packet. If 4 peripherals are supported this number is always 0 to denote that there is no room to share the polling packet time interval. The Channel Hop Sequence Type identifies the hopping sequence used and the Channel Hop Sequence Pointer identifies where in this sequence the base transceiver currently resides. The length of the hopping sequence can vary depending on the application. The Channel Hop Rate supports from one hop every volley (fastest and preferred setting) to one hop every n volleys. RESERVED leaves room for future features. The Peripheral Field Identifier and Peripheral Field Length mark the beginning of the peripheral header/data segments. The Peripheral Header contains the short mating number and peripheral data field length information at a minimum. The peripheral header is followed by the given peripheral's data field. At the end of the packet a frame check, used to detect transmission errors, is included.

In the case of normal peripherals each of the sub-packets applies only to the specifically addressed peripheral. In special cases, as illustrated in FIG. 7 for base transceiver 7, a sub-peripheral may join the normal peripheral and share its time slot as indicated at 84. In this case multiple sub-packets addressed to a given time slot contain information for the peripheral and the sub-peripheral. An example of a sub-peripheral for a gaming application is a wireless gas-pedal for a separate main peripheral containing a steering wheel and shifter.

Once a base transceiver 12 has completed polling peripherals 14, each of the peripherals respond in their assigned time slots. In the case of the sub-peripheral illustrated in FIG. 7, it shares surplus time slot space with another peripheral. As described above, when the sub-peripheral joins it detects the presence of a peripheral 14 that can support a sub-peripheral and joins the appropriate time slot.

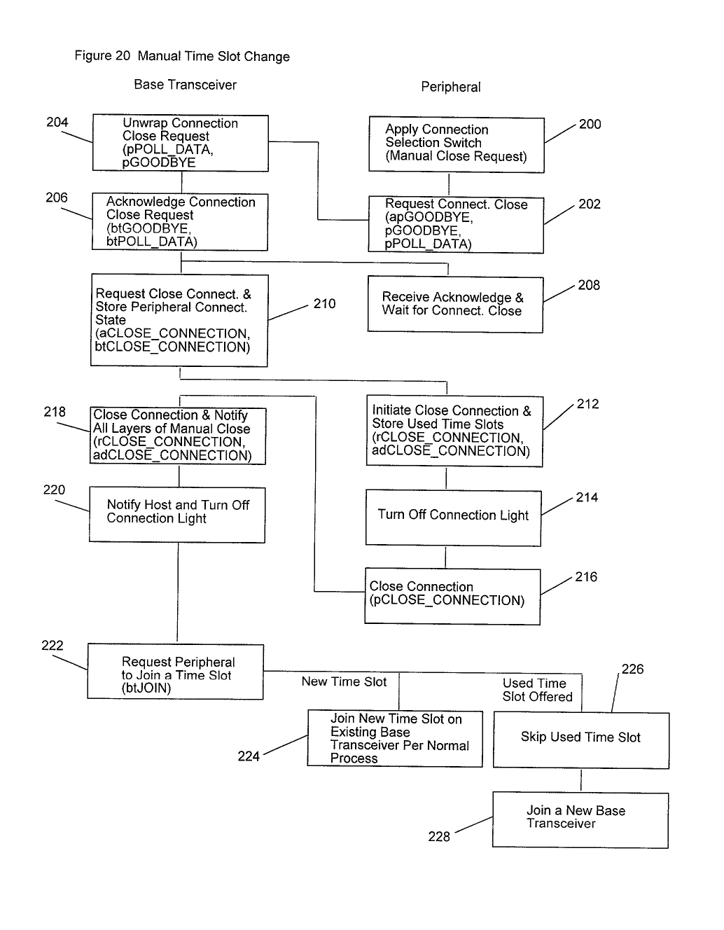

If the user is not satisfied with the association such as in the case where the sub-peripheral could join any one of several main peripherals, the time slot can be manually changed by the user by applying the connection selection switch 86 as shown in FIG. 1. The process of manually changing a connection is outlined in FIG. 20. The application of the connection selection switch is detected by the application layer in the peripheral 200. This layer sends an apGOODBYE message to the adaptation layer 202. The adaptation layer then sends a pGOODBYE message to the RF layer. This message and the previous message have their selection switch flags set to yes to indicate that the event was triggered by the actuation of the connection selection switch 86. The RF layer then wraps the pGOODBYE message in a pPOLL_DATA message and transmits it wirelessly to the base transceiver. The RF layer at the base transceiver unwraps the contents and sends the pGOODBYE to the base transceiver adaptation layer 204. The base transceiver adaptation layer generates a btGOODBYE message and sends it to the base transceiver RF layer for transmission within a btPOLL_DATA message 206. The btGOODBYE message is received by the peripheral, unpacked by the peripheral RF layer and recognized by the adaptation layer. The peripheral is thus aware that the connection will be closed shortly and the base transceiver understands that this closure was due to the actuation of the connection selection switch 208. The base transceiver prepares for both closing the connection and expecting a new join attempt by the peripheral.

The base transceiver then closes the connection to the peripheral, turns off its connection light for the peripheral and begins polling for the peripheral to rejoin the base transceiver 210. To close the connection the base transceiver adaptation layer sends an aCLOSE_CONNECTION message with instructions to save the time slots of previously attempted joins from this peripheral. The base transceiver RF layer then constructs a btCLOSE_CONNECTION message and transmits it RF wirelessly to the RF layer of the peripheral. The peripheral RF layer sends a rCLOSE_CONNECTION message to the peripheral's adaptation layer 212. The adaptation layer sends an adCLOSE_CONNECTION message to the peripheral application layer and the application layer notes that the connection has been closed and turns off a connection light 214, as shown in FIG. 1, if it is present. The peripheral RF layer then constructs a pCLOSE_CONNECTION message and sends this RF wirelessly to the base transceiver RF layer to indicate the connection is closed from the peripheral end 216. The base transceiver RF layer constructs a rCLOSE_CONNECTION message and sends this to the base transceiver adaptation layer 218. The base transceiver adaptation layer constructs an adCLOSE_CONNECTION message and sends this to the base transceiver application layer. The base transceiver application layer notes the connection is closed, notifies the host system and turns off the connection light associated with this connection 220. Back at the base transceiver RF layer a btJOIN message is sent out, inviting the peripheral to join a new time slot, where such time slot is mapped to a different physical or logical port on the host system 222. During the new join operation, the base transceiver remembers the reason for the previous connection closure as denoted by the received selection switch flag. When the same peripheral tries to rejoin, the base transceiver thus attempts to place it in another time slot that the peripheral did not previously occupy 224. Likewise the peripheral attempts to rejoin the same base transceiver, rather than responding to potentially other join requests from other base transceivers. If no new time slots are available, the base transceiver btJOIN message offers a time slot previously used by the peripheral. In this case the peripheral begins to search for new base transceivers to join 226, 228, coming back to this base transceiver only when these options have been exhausted.

If the user is still not satisfied with the peripheral time slot assignment, shown visually with a light on the base transceiver 12, the time slot can be manually changed again by the user by applying the connection selection switch 86 as shown in FIG. 1.

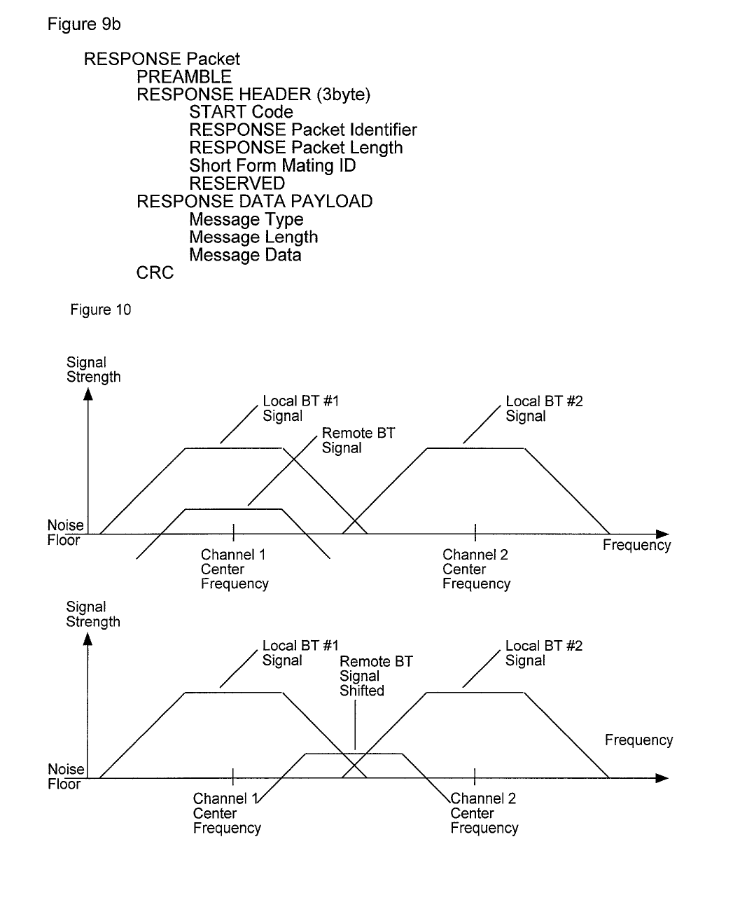

The format of a peripheral response packet 88 is shown in FIG. 9a. The packet 88 consists of a preamble 90 followed by a peripheral header 92 and a peripheral data component 94. The header 92 contains the connection address and other control information. A frame check 95 terminates the packet 88.

FIG. 9b shows a detailed breakdown of a representative peripheral response packet for a wireless game peripheral application. The header, like all system packets starts with a START Code to facilitate word boundary alignment. The RESPONSE Packet Identifier and RESPONSE Packet Length identify this packet to be of the RESPONSE type and of the length indicated. The Short Form Mating ID is the short address assigned during the connection of the peripheral to the base transceiver. RESERVED leaves room for future features. The RESPONSE DATA PAYLOAD is composed of a message composed of Message Type, Message Length and Message Data fields. At the end of the packet a frame check, used to detect transmission errors, is included.

Radio frequency device coordination between base transceivers is supported by the exemplary RF system described here. Coordination occurs in two situations: 1) when a new base transceiver is started up and, 2) when a system of base transceivers is running in steady state operation. The transmissions of base transceivers in close vicinity are synchronized so that adjacent base transceivers do not saturate each other's receivers during polling transmissions. The method of listening and synchronization of polling transmissions between base transceivers running in steady state operation is covered in detail previously in the description of the preferred embodiments.

Whenever a new base transceiver 12 is powered up it performs power up and start up sequences. During this process it scans the radio frequency spectrum to record any base transceivers 12 that are already operating on given frequencies and to characterize the transmission quality of available channels. The selection of operating channels is selected by the first base transceiver in a given radio frequency operating range, and this information is broadcast to and recorded by newly joining base transceivers who listen to its synchronization packet. Information contained in the synchronization packet greatly simplifies the discovery and joining process for new base transceivers.

In each base transceiver synchronization packet and also in the poll packet, information identifying the frequency hopping sequence of each base transceiver is stored. The new base transceiver uses this information to track and read information from adjacent base transceivers to help it select its hopping sequence.

By capturing one complete synchronization packet from one base transceiver in the system, a new base transceiver gathers enough information about all other base transceivers in the system to allow it to begin operating in an unused hopping sequence starting point.

A palette of good operating frequencies is recorded from the Channel List field of the synchronization packet as shown in FIG. 11b. Next, also with reference to FIG. 11b, by examining the Channel Hop parameters (Channel Hop Sequence Type, Channel Hop Sequence Pointer, and Channel Hop Rate) and the Channel Hop Pointers already used in the BT Map field, a hopping sequence is chosen that does not clash with frequencies used by other base transceivers 12 in the domain. For example, if sequences 1-2-3-4 and 2-3-4-1 are in use, a new base transceiver might use frequencies 3-4-1-2. As described previously, the base transceiver 12 listens to any other base transceivers 12 and synchronizes its polling volley with others who are in close vicinity within its RF domain.

The new base transceiver 12 uses its RSSI circuitry 26 to detect relative base transceiver distances. If all base transceivers 12 are not in close vicinity to the new base transceiver 12, but are still detectable, the new base transceiver 12 can slightly shift its center frequency to reduce potential interference. Thereafter it operates independently with no further synchronization requirement.

FIG. 10 illustrates this situation. Two local base transceivers #1 and #2 are operating on channels 1 and 2. A remote base transceiver starts up initially on channel 1 and detects that base transceiver #1 is beyond a certain distance by using its RSSI function to measure the signal strength of base transceiver #1's transmission e.g. an RSSI voltage corresponding to a −50 dBm signal would mean base transceiver is nearly out of range. The remote base transceiver then shifts its operating channel to be between the two channels 1 and 2 respectively used by the local base transceivers #1 and #2. In this position the remote base transceiver signal is outside of the primary band area of both local base transceivers #1 and #2 and hence negligible interference occurs.

In any system containing multiple base transceiver systems having overlapping RF domains, as illustrated in FIG. 7, only one synchronization packet 68 is present for all base transceivers 12 in association with any one polling volley. All base transceivers 12 not producing a synchronization packet 68 at a given time listen to the synchronization packet 68 of the designated base transceiver 12 and adjust their polling timing by a small increment.

The format of the synchronization packet 68 is shown in FIG. 11a. Synchronization packets 68 contain a preamble 96 for receiver training, a header 98, a payload 100 and a 16 bit CRC 102 for error detection. The synchronization packet payload 100 contains frequency hopping IDs to identify the hopping pattern, hopping rate, time slot allocation of associated peripherals, and inter-base transceiver control and data messages.

FIG. 11b shows a detailed breakdown of a representative base transceiver synchronization packet for a wireless game peripheral application. The header, like all system packets starts with a START Code to facilitate word boundary alignment. This code is chosen to be a member of all the direct sequence code sets used by the system and hence appears regardless of the coding method used for the contents of any system packet. All fields in the remainder of the packet are encoded using the direct sequence code set currently enabled. The SYNC Packet Identifier and SYNC Packet Length identify this packet to be of the SYNC type and of the length indicated. The Code Type Used field identifies the type of direct sequence code set used by the system and is a second check for the automatic code-set-detection capability built into the system.

Automatic code-set-detection is supported by the system. Due to the parallel nature of the controller, a packet can be decoded using multiple code sets. If the correct code set is chosen, the number of decode errors is small i.e. the number of bit-errors found while matching received bits to a defined code set is small. Also for the correct code set, the SYNC Length in bytes field matches the number of bits decoded. As a further check, the Code Type Used field will match the code set type identifier of the code set chosen for decoding and the CRC will be correct for the correct decoding. Using these multiple detection methods, the correct code set to use for decoding versus the incorrect code set can easily be determined. Automatic code-set-detection can decode code types having either different error correction capabilities or different codes with similar error correction capabilities. Due to the computational burden and parallel hardware costs, the system preferably can decode and differentiate 3 code sets having one, two and three bit-error correction capabilities. Such code sets are of the 4:16, 6:16 and 9:16 variety (raw input bits to code size). Decoding and differentiating more code sets is possible with more parallel hardware and/or faster processors.

The code type used is set by the first base transceiver that powers up in a RF operating range based upon the noise scan characterization it does upon initial power up. If the noise level in a RF operating range is found to be low, the code type chosen supports single bit error correction (9:16 code) and maximizes the transmission throughput. If a line rate of 1.5 Mchips per second is supported, this means that the system has a 9/16 times 1.5 Mchips per second or 844 kbits per second maximum data transmission throughput. If the noise level is high, e.g. less than 20 dB of signal to noise separation, or the desired noise immunity high, a code type is chosen that supports three bit error correction (4:16 code) and thus supports sub-optimal but best-effort transmission throughput of 375 kbits per second for a line rate of 1.5 Mchips per second. If during normal operation, the general level of environmental noise increases or decreases, the code set used can be changed dynamically. The base transceiver detecting the change in noise switches to a new code set before it broadcasts a synchronization packet at the appropriate time. All other base transceivers listen to this synchronization packet broadcast, detect the change in codes and confirm the code type from the Code Type Used field. Thereafter all members of the system begin using the new code set.

Continuing on with the SYNC Packet field description based on FIG. 11b, the RESERVED field leaves room for future features. Following this is the APPLICATION DATA portion of the packet. The order in which the synchronization packet is broadcast is the same order in which the base transceivers are represented in the BT Map portion of the synchronization packet. As shown in FIG. 11b, if the synchronization packet shown was broadcast by base transceiver 2 (BT ID #2 in the BT Map list), the next polling volley would contain no synchronization packet, because the entry in the BT Map list is a NULL value. The hop pointers values of the NULL entry are used by a new base transceiver joining the existing base transceivers to determine the next unused starting point on the frequency hopping sequences for the poll packet and synchronization packets. All synchronization packets of all existing base transceivers mirror this information, so a new base transceiver merely needs to find one synchronization packet to get sufficient information to join the system.

Channel and hop information about the base transceiver that is transmitting the synchronization packet is included in the packet. The synchronization packet sequence, synchronization packet hop pointer, and period between synchronization packets is found in the SYNC Sequence Type, SYNC Sequence Pointer and BT Sync Period fields respectively. Next the BT ID Number is the unique identification number for the base transceiver, where the last four bits indicate if this base transceiver can share the poll packet portion of the polling volley time slot with other base transceivers. A value of 0 indicates one base transceiver per hop frequency. A value of 3 indicates four base transceivers of this type can share a given hop frequency (see FIG. 7, base transceivers #4 to #7). The BT Subslot Number tells other base transceivers what subslot this base transceiver occupies in the polling packet portion of the polling volley time slot. The number of channels used by the base transceivers in a RF operating range and the channel list indicating center frequencies of these channels is contained in the Number of Channels and Channel List field. These parameters are set during start up operation and can be changed if a channel becomes unusable or previously unusable channels become usable. The channel hopping sequence, the currently used channel by this base transceiver (index to a channel in the sequence), and the rate at which this base transceiver changes channels in increments of polling volleys are contained in the Channel Hop Sequence Type, Channel Hop Sequence Pointer and Channel Hop Rate fields respectively.

The BT map fields contain information on the channel hop sequence position and sync hop position for each base transceiver 12 in the domain. The use of this information is described in more detail below in relation to FIG. 12a.

In the next group of fields in the synchronization packet, information about the peripherals associated with the base transceiver is optionally included. As shown in FIG. 6, the peripheral map is used by second and other base transceivers to attempt to stagger their peripheral response transmissions to avoid the peripheral transmissions of the first base transmitter currently transmitting a synchronization packet. Before the peripheral map (P Map), the number of peripherals in the map and the number of time slots is defined in the Number of Peripherals and the Number of Slots fields. Next the peripheral map (P Map) field represents the peripherals associated with the base transceiver broadcasting the synchronization packet. The format of this map is the peripheral identification number followed by the time slot that it occupies in the response packet intervals. For the example shown, peripheral 4 is a sub peripheral since it shares slot 3 with peripheral 3. Peripheral type information is encoded in the last 2 bits of the peripheral identification number or can be implicitly determined from its peripheral map representation.

In the last part of the synchronization packet inter-base transceiver message fields are found. Messages to add a new base transceiver, to abandon a newly unusable channel, and to add a newly usable channel are supported with their associated message data fields (if any). The new base transceiver (New BT) message is shown in the table in FIG. 12b as a new peripheral is being added. The message set can be expanded to include any such required inter-base transceiver message type.

The final field in the synchronization packet it the frame check field that is used to detect if any bit errors occurred in the synchronization packet.

Over time each base transceiver 12 serves as the synchronization source for all the other base transceivers 12 by producing a synchronization packet at non-coincident times with other base transceivers 12. In this way the synchronization of all base transceivers 12 in the system is maintained. Self-checks are also implemented to prevent the polling interval and polling frequency of the entire system from drifting too far from the baseline polling volley period.

The addition of new base transceivers is coordinated from information obtained from the synchronization packet of one of the base transceivers existing in the RF operating range. As each new base transceiver joins the base transceivers already in the RF operating range, it reads the first synchronization packet it finds. Additional synchronization packets might also be read to add certainty to this process. Using the BT Map from the synchronization packet, the new base transceiver finds the NULL entry. The NULL entry contains the pointer to the next unused starting point in the poll packet channel hopping frequency set. The NULL entry location in the BT Map list also indicates where a polling volley without a synchronization will occur and where all other existing base transceivers are listening for the entry of a new base transceiver. In the example synchronization packet of FIG. 11b this is after base transceiver 2. The new base transceiver broadcasts its synchronization packet in this polling volley. All other base transceivers hear the new base transceiver and adjust their BT Maps and synchronization periods to make room for the new base transceiver and also make room for another new base transceiver to join by opening up a new polling volley with no synchronization packet. If all frequencies are currently used, no NULL entry will appear in the BT Map and the new base transceiver will not be allowed to join in the RF operating range.

As an example of this process FIG. 12a shows a radio frequency system using four channel hopping frequencies in which another base transceiver #2 is added and the synchronization packets 68 are adjusted to support this addition. During each polling interval the frequency of each base transceiver #1, #2 changes as it hops through the defined frequency sequence (1-2-3-4). The sequence shown is representative only and does not necessarily represent a linear sequence of frequency changes.

FIG. 12b is a tabular summary of each of the important system during the polling volley when BT #2 is added to the system in line 106 of FIG. 12a. The five polling volley numbers 103 shown at the top of FIG. 12a are shown in the Polling Volley Number line 250 in the table. SYNC Channel line 252 is the channel on which a synchronization packet is being broadcast or anticipated to be broadcast. In polling volleys 1 and 2 base transceivers #1 and #2 (BT #1 and BT #2) broadcast synchronization packets on channel 1. Polling volley number 3 is a “listening” polling volley where base transceivers #1 and #2 listen to channel 1 for a new synchronization packet in case yet another new base transceiver wishes to join the system. In polling volleys 4 and 5 base transceivers #1 and #2 again broadcast a synchronization packet, this time on channel 4. The next two lines of the table are base transceivers #1 and #2 BT Map states 254 and 256. These maps of internal states are broadcast by each base transceiver in their respective synchronization packets at the appropriate polling volley times. During polling volley 1, base transceiver #1 is not aware of base transceiver #2. Base transceiver #1 BT Map for polling volley 1 shows that base transceiver #1 is currently using channel 1 for both polling/response packets and for synchronization packets i.e. BT#1,1,1 BT Map table entry (the parameters of which are defined in FIG. 11b). Pointer 1 corresponds to channel one for this example. Also in this BT Map, the “NULL,4,4” entry shows that a synchronization packet can be introduced in the next polling volley, polling volley 2, after base transceiver #1 broadcasts its synchronization packet. This NULL entry also indicates that the channel corresponding to index pointer 4, in this case channel 4, could have been used by a new base transceiver for broadcasting both poll/response and synchronization packets and by inference that channel 1 can be used in the next polling volley 2. During polling volley 1, base transceiver #2 is listening to the synchronization packet of base transceiver #1. From base transceiver #1's synchronization packet, base transceiver #2, thus selects channel hop and synchronization pointers (1,1) for polling volley 2 and times its first synchronization packet broadcast to correspond to polling volley 2. In polling volley 2, the BT Map for base transceiver 2 is broadcast on channel 1 to base transceiver 1 (listening at this time) in a synchronization packet. The BT Map information shown for base transceiver #1 is from the beginning of the interval and hence has not been updated to reflect the reception of this synchronization packet broadcast by base transceiver 2. In polling volley 3, base transceiver #1 has heard the synchronization packet broadcast from base transceiver #2 in polling volley 2 and the BT Maps of base transceiver #1 and #2 are now synchronized to reflect the presence of two base transceivers in the system. The “Listening BTs” line 262 and “SYNC Packet Broadcasting BTs” line 264 of the table in FIG. 12b shows when a given base transceiver is listening for synchronization packets from other base transceivers or alternately is broadcasting a synchronization packet. During polling volley 1 for example, base transceiver #2 is just joining the system and hence is listening to the synchronization packet being broadcast by base transceiver #1 on channel 1. In the next polling volley 2, base transceiver #1 is listening and base transceiver #2 is broadcasting a synchronization packet. In polling volley 3, both base transceivers #1 and #2 are listening etc. The “BT #1 SYNC Period” line 258 and “BT #2 SYNC Period” line 260, also found in the broadcast synchronization packets, are the time between synchronization packet broadcasts. In polling volleys 1 and 2 base transceiver #2 is in the process of joining the system and hence base transceiver 1's period is 2 i.e. broadcast a synchronization packet every second polling volley. By polling volley 3, base transceiver 2 has joined the system and now both base transceivers have a new extended synchronization periods of 3 polling volleys. Finally the “SYNC Message BT #1” line 266 and “SYNC Message BT #2” line 268 of the table show the message being broadcast in a given synchronization packet i.e the Message Type and Message Data fields as shown in FIG. 11b. During polling volley 2, base transceiver announces its arrival by issuing a “New BT” message.

The steady state is indicated at line 104. A single base transceiver #1 hops through a sequence 1-2-3-4. There are n=1 base transceivers and the base transceiver #1 emits a sync packet 68 each n+1=2 polling volleys. At all times one polling volley in time from at least one of the base transceivers has no synchronization pulse and all existing system base transceivers listen to this channel at this time. As a new base transceiver is added to the system it picks a new hopping sequence by listening to the NULL entry in the BT Map, as shown in FIG. 12b, of an existing base transceiver's synchronization packet, and joins during the polling volley that has no synchronization pulse. The new base transceiver inserts a synchronization packet in this polling volley and places a “New Base Transceiver” message in the message area of its synchronization packet.

Specifically as shown in FIG. 12a, addition of a second base transceiver #2 is shown at line 106. In the first polling volley interval base transceiver #2 listens to the synchronization packet of base transceiver #1 and establishes that no synchronization packet is generated in the polling packet transmitted on channels 2. As seen in FIG. 12b, this is determined from NULL entry for the BT Map of base transceiver #1 during polling interval 1. The base transceiver #2 then waits for the polling volley associated with channel 2 of base transceiver #1 and transmits a synchronization packet 68 on channel 1 during the second polling volley interval. Base transceiver #1 hears this synchronization packet and knows that another base transceiver has arrived by its presence and the New BT message found in the synchronization packet. Base transceiver #1 then delays its next synchronization packet 68 to the next polling volley (number 4), which was to be on channel 3 but now is shifted to channel 4.

In general, the next and subsequent base transceivers 12 responsible for generating a synchronization packet delay their packets by one polling volley cycle to accommodate the new base transceiver and increase the period between their synchronization packets by one polling volley. This opens up a new polling volley with no synchronization pulse so another new base transceiver 12 can be added later. As before all existing base transceivers listen during this period for any subsequent base transceivers.

If a base transceiver leaves the polling volley sequence, the absence of its synchronization packet is noticed by all base transceivers in the system. At this point all base transceivers roll back their synchronization packet timing by one packet and reduce the period between their synchronization packets by one polling volley. If the next base transceiver was due to generate a synchronization packet in the next packet volley and more than one base transceiver remains, it skips its synchronization packet volley to make room for subsequent base transceiver packet volleys for the first transition cycle.

This is illustrated at line 108 of FIG. 12a. When no sync packet 68 associated with the polling volley on channel 2 is heard by base transceiver #1, it moves its sync packet 68 from the polling volley associated with channel 4 to the polling volley associated with channel 3, and then continues sending sync packets each second polling volley. Base transceiver #1 also updates its BT Map to reflect the absence of the second base transceiver.

Or alternatively, the next subsequent synchronization packets 68 on each of the remaining base transceivers 12 occur at the designated time, but thereafter the interval between each of the base transceivers 12 issuing synchronization packets 68 is reduced by one polling volley interval. This closes the gap left by the departing base transceiver 12 and leaves a single gap for a new base transceiver 12 to begin actively polling.

If all available channels are occupied, all polling volleys at all times will have one volley with a synchronization packet and hence a new base transceiver will not be allowed to operate in the same local area as the already present base transceivers. To allow operation of this base transceiver, it could be moved farther away so that it could shift it frequencies as described previously or so it would be out of range of other base transceivers.

When a base transceiver 12 or peripheral 14 initially starts up they both perform a complete noise scan of the usable spectrum. During this scan the background noise and the presence of active channels is detected and recorded. The peripheral shares this information with the base transceiver to which it bonds.

During normal operation the base transceiver 12 does progressive noise scans. Over a period of time during normal operation the base transceiver 12 will ask all of its connected peripherals 14 to scan individual channels and report back the results. The base transceiver thus receives scan results for all defined system channels after several polling volleys. In this way it has a current and dynamically updated view of the quality of all channels.

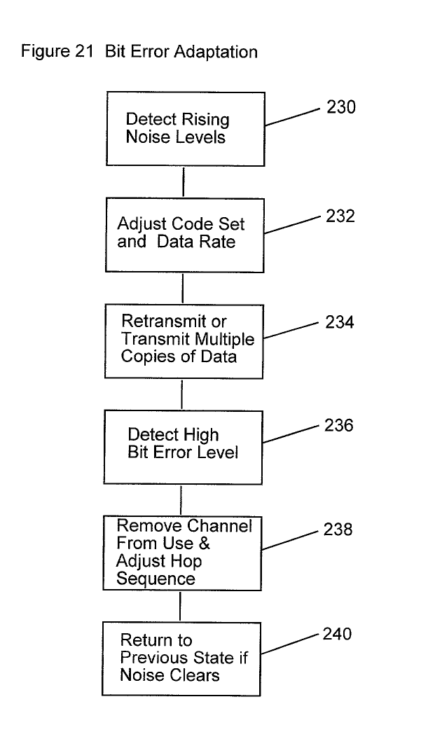

If a channel is found to exceed a defined noise power threshold as measured with RSSI measurements, the average noise value is recorded and the channel is marked as being degraded. As outlined in FIG. 21, the channel is monitored for bit errors associated with rising noise levels 230 and additional actions are taken as the number of bit errors increase. Prior to a degraded channel being declared as unusable, an attempt is made to change spreading code values (the process of which was discussed previously) 232 so that the system operates at a slower data throughput rate and is capable of greater error correction. Data may also be retransmitted or transmitted twice in the same polling volley, depending on the delay and data throughput requirements of the application 234. As bit errors on a given channel exceed the correction capacity 236, i.e. the CRC does not match the error corrected data output of the system even with up to 3 levels of error correction, the channel is abandoned and the frequency hopping sequence adjusted 238. The first base transceiver to issue a synchronization packet after a channel is found to be unusable, but not broadcasting on the unusable channel, places a “Channel Abandon” message in the message field of the synchronization packet and changes its hopping pattern to a channel set with fewer channels. This base transceiver updates its BT Map so that it is the base transceiver pointing to the first frequency of the new hopping pattern. It also adjusts its BT Map record of the other base transceiver pointers to start them in subsequent hopping patterns. As all other base transceivers are listening to the first base transceiver's synchronization packet, they see the change and the “Channel Abandon” message and thus adjust their BT Map and internal states as directed by the first base transceiver.

When a channel is abandoned, special cases exist. If the base transceivers in the RF operating range are running at one frequency below capacity, the polling volley without a synchronization packet is eliminated to make room. If the system was running using all channels simultaneously, one base transceiver is removed from the BT Map of the first base transceiver and it drops out of active operation. From that point on, the removed base transceiver listens for a new opportunity to join the system. When the noise on a channel or a new channel clears 240, the first base transceiver producing a synchronization packet following this adds another channel, changes the frequency hopping sequence as above and issues a “Channel Add” message in its synchronization packet. All other base transceivers in the system hear this change and adjust their frequency hopping sequences. A polling volley with no synchronization packet is thus created and the base transceiver that had to go into a listening mode, now rejoins the system by normal base transceiver add methods.

If at any time due to a lost signal or following a transition, the internal BT Map of a given base transceiver or base transceivers does not match that heard from the current synchronization packet of another, a bad transition is detected. A BT Map mismatch occurs when a channel is dropped or added, but in this situation a special transition message accompanying the transition identifies the special case. In other situations, such a mismatch coming unexpectedly is a sign that the system is in danger of using conflicting channels. To avoid frequency hop collisions, the affected base transceiver sends a btGOODBYE message to its peripherals telling them to save their association with this base transceiver and that they should try to reconnect later. The affected base transceiver then stops transmitting. The affected base transceiver listens for several polling volleys until it relearns the operational parameters of the base transceivers that continue to transmit. After a random delay interval, added to avoid contention with potentially multiple such base transceivers, the affected base transceiver rejoins the transmitting base transceivers in the RF operating range by normal base transceiver add methods.

While preferred embodiments of the invention have been disclosed, immaterial changes may be made to what has been described without departing from the essence of the invention.

We claim:

1. An RF system, comprising:
an RF section;
a processor operably connected to the RF section;
an input/output subsystem operably connected to the processor; and
the processor being configured to control transmission of sync signals from the RF section in response to receiving sync signals at the RF section from another RF system.

2. The RF system of claim 1 in which the input/output subsystem is operably connected to a host selected from the group consisting of a video game console, a set top box, a consumer electronic device, a computer and data networking equipment.

3. The RF system of claim 2 in which the host is a video game console.

4. The RF system of claim 1 in which the processor is configured to cause the RF section to transmit polling volleys in a time division manner.

5. The RF system of claim 4 in which the processor is configured to cause the RF section to transmit a sync signal in a sync slot associated with a polling volley.

6. The RF system of claim 5 in which the processor is configured to cause the RF section to transmit a sync signal in association with a first polling volley and then listen for sync signals from other RF systems in association with a subsequent polling volley.

7. The RF system of claim 6 in which the processor is configured to cause the RF section to delay sending a sync signal when a sync signal is received from another RF system.

8. The RF system of claim 7 in which the processor is configured to cause the RF section to advance the sending of a sync signal when a sync signal is no longer received from another RF system.

9. The RF system of claim 1 in which the processor is configured to receive responses from peripherals transceiver in time slots associated with each polling volley, in which each peripheral transceiver is assigned a specific time slot.

10. The RF system of claim 9 further comprising a visual indicator operably connected to the processor for indicating a change in assignment of a time slot for a peripheral transceiver.

11. A method for exchanging information between transceivers, the method comprising the steps of:
transmitting and receiving signals, including sync signals, from a first base transceiver; and
controlling transmission of sync signals from the first base transceiver in response to receiving sync signals from another base transceiver.

12. The method of claim 11 in which transmitting signals comprises:
transmitting signals from the first base transceiver to a first peripheral transceiver in successive polling volleys on a first series of frequencies selected from a set of frequencies.

13. The method of claim 12 in which controlling transmission of sync signals comprises:
transmitting a sync signal from the first base transceiver in a time slot associated with a selected polling volley;
in association with a succeeding polling volley to the selected polling volley, the first base transceiver delaying sending a sync signal to permit another base transceiver to send a sync signal;
in association with the succeeding polling volley, the first base transceiver listening for a sync signal from another base transceiver; and
adjusting the start time of polling volleys used by the first base transceiver upon receipt of a sync signal from another base transceiver.

14. The method of claim 13 further comprising:
transmitting signals from a second base transceiver to a second peripheral transceiver in association with the successive polling volleys on a second series of frequencies selected from the set of frequencies, where the first series and second series of frequencies do not clash with each other.

15. The method of claim 11 in which the first base transceiver communicates with a host selected from the group consisting of a video game console, a set top box, a consumer electronic device, a computer and data networking equipment.

16. The method of claim 15 in which the host is a video game console.

17. The method of claim 11 in which the first base transceiver transmits polling volleys in a time division manner.

18. The method of claim 17 in which the first base transceiver transmits a sync signal corresponding to a polling volley in a sync slot associated with the polling volley.

19. The method of claim 17 in which the first base transceiver transmits a sync signal in association with a first polling volley and then listens for sync signals from other base transceivers in association with a subsequent polling volley.

20. The method of claim 19 in which the first base transceiver delays sending a sync signal when a sync signal is received from another base transceiver.

21. The method of claim 11 in which the first base transceiver and second base transceiver are colocated and each is synchronized to start a polling volley at the same time.

22. The method of claim 11 in which the sync signals are transmitted as part of packets carrying data to other base transceivers.

23. The method of claim 22 in which the packets contain hop sequence information.

24. The method of claim 23 in which the packets contain peripheral state information.

25. The method of claim 24 in which the packets contain inter-base transceiver messages.

26. The method of claim 12 in which the first set of frequencies follows a hopping pattern.

27. The method of claim 26 in which the first set of frequencies and the second set of frequencies follow a hopping pattern.

28. The method of claim 11 in which the first base transceiver begins transmitting upon power up with a random delay to avoid clashing with another base transceiver.

29. An RF system, comprising:
an RF section;
a processor operably connected to the RF section;
an input/output subsystem operably connected to the processor and to a game console; and
the processor being configured to scan a set of channels for at least one channel suitable for communication with another RF system.

30. The RF system of claim 29 in which the processor is configured to select channels for use that have a lower degree of impairment than channels not selected for use.

31. The RF system of claim 30 in which the processor is configured to adapt for impaired channels by using a method selected from the group consisting of coded data changes, abandoning unusable channels and changing frequency hopping sequences, variable data rates and re-transmitted data.

32. A method of exchanging game information between transceivers, the method comprising the steps of:
scanning a set of available channels for at least one channel suitable for communication between the transceivers; and
exchanging game data between the transceivers using at least one suitable channel.

33. The method of claim 32 further comprising the step of preferentially using channels having lower degree of impairment.

34. The method of claim 33 further comprising the steps of ranking the available channels according to degree of impairment and selecting the channels having the least degree of impairment.

35. The method of claim 34 further comprising the step of adapting for impaired channels by using a method selected from the group consisting of coded data changes, abandoning unusable channels and changing frequency hopping sequences, variable data rates and re-transmitted data.

36. An RF system, comprising:
an RF section;
a processor operably connected to the RF section;
an input/output subsystem operably connected to the processor and to a user interface;
a manually operated switch operably connected to the processor; and
the processor being configured to respond to operation of the manually operated switch to cause the RF section to transmit a request selected from the group consisting of a request for a change of time slot assignment for communications between the base transceiver and the RF system and a request for a change of base transceiver with which the RF system is to communicate.

37. The RF system of claim 36 in which the request is a request transmitted to a base transceiver with which communication has already been established.

38. The RF system of claim 37 in which the request is a request for a change of time slot assignment for communications between the base transceiver and the RF system.

39. The RF system of claim 36 in which the request is a request to change to communication with a different base transceiver.

40. The RF system of claim 36 in which the user interface is a user interface for a game.

41. A method for changing communications between a base transceiver and an RF system, the method comprising the steps of:
assigning a time slot to a peripheral RF system for responding to a first base transceiver; and
manually switching to a different time slot for sending information to the base transceiver.

42. The method of claim 38 further comprising the step of visually displaying an indication of the assigned time slot on the first base transceiver.

43. The method of claim 41 further comprising manually switching to communication with a second base transceiver.

44. A method of exchanging data between transceivers, the method comprising sequentially repeating the steps of:
transmitting a polling volley from a base transceiver to plural peripheral transceivers, wherein the polling volley contains sequential packets addressed to the plural peripheral transceivers; and
the plural peripheral transceivers responding in order to the polling volley after the termination of the polling volley.

45. The method of claim 44 in which the peripheral transceivers are game controllers communicating with a base transceiver associated with a game console.

46. The method of claim 44 in which the peripheral transceivers cooperate with each other.

47. The method of claim 44 in which:
the polling volley contains time slots arranged in order with each time slot addressed to a different peripheral transceiver; and
the responses to the polling volley are arranged in an order corresponding to the order of the time slots of the polling volley.

48. The method of claim 47 in which the response of each peripheral transceiver is assigned to a specific time slot associated with the polling volley.

49. The method of claim 48 in which at least one response time slot is divided into sub-intervals assigned to plural cooperating sub-peripherals.

50. A method of exchanging data between plural base transceivers operating on a common frequency assignment and at least one peripheral transceiver associated with each base transceiver, the method comprising the steps of:
each of the plural base transceivers transmitting a sync packet at times at which none of the other of the plural base transceivers are transmitting a sync packet;
each of the plural base transceivers listening for sync packets from others of the plural base transceivers; and
each of the plural base transceivers adjusting a respective time clock associated with the base transceiver according to information contained in the sync packets.

51. The method of claim 50 further comprising the step of:
controlling transmission of sync signals from each base transceiver in response to receiving sync signals from other base transceivers.

52. The method of claim 51 further comprising the step of:
transmitting signals from each respective base transceiver to a corresponding peripheral transceiver in successive polling volleys on a first series of frequencies selected from a set of frequencies.

53. The method of claim 52 in which controlling transmission of sync signals comprises:
transmitting a sync signal from the first base transceiver in a time slot associated with a selected polling volley;
in association with a succeeding polling volley to the selected polling volley, the first base transceiver delaying sending a sync signal to permit another base transceiver to send a sync signal;
in association with the succeeding polling volley, the first base transceiver listening for a sync signal from another base transceiver; and
adjusting the start time of polling volleys used by the first base transceiver upon receipt of a sync signal from another base transceiver.

54. The method of claim 50 further comprising the steps of:
transmitting a polling volley from each base transceiver to plural peripheral transceivers, wherein the polling volley contains sequential packets addressed to the plural peripheral transceivers; and
the plural peripheral transceivers responding in order to the polling volley after the termination of the polling volley.

55. The method of claim 54 in which the peripheral transceivers are game controllers communicating with a respective base transceiver associated with a game console.

56. The method of claim 55 in which the peripheral transceivers cooperate with each other.

57. The method of claim 40 in which:
the polling volley contains time slots arranged in order with each time slot addressed to a different peripheral transceiver; and
the responses to the polling volley are arranged in an order corresponding to the order of the time slots of the polling volley.

58. The method of claim 57 in which the response of each peripheral transceiver is assigned to a specific time slot associated with the polling volley.

59. The method of claim 57 in which at least one response time slot is divided into sub-intervals assigned to plural cooperating sub-peripherals.

60. A method of exchanging data between transceivers, the method comprising sequentially repeating the steps of:
during a polling volley, each of plural base transceivers transmitting a data packet in different time slots on a single channel to a corresponding one of plural peripheral transceivers; and
the plural peripheral transceivers responding in order to the packets in the polling volley after the termination of the polling volley.

61. The method of claim 60 in which:
the polling volley contains time slots arranged in order with each time slot addressed to a different peripheral transceiver; and
the responses to the polling volley are arranged in an order corresponding to the order of the time slots of the polling volley.

62. A method of synchronizing N plural transceivers, the method comprising the steps of:
each of the N plural transceivers transmitting a sync signal when none of the others of the N plural transceivers are transmitting a sync signal;
each of the N plural transceivers transmitting data in polling volleys;
each of the N plural transceivers transmitting a sync signal each N+1 polling volleys; and
each of the N plural transceivers synchronizing to the sync signals from the other base transceivers.
